(19) United States
(12) Patent Application Publication
(10) Pub. No.: US 2015/0055237 A1
(43) Pub. Date: Feb. 26, 2015

(54) ADJUSTABLE SOLAR CONCENTRATOR ASSEMBLY AND METHODS OF USING SAME

(71) Applicant: One Earth Designs, Inc., Cambridge, MA (US)

(72) Inventors: Tin Y. Chan, Hong Kong (CN); Yim P. Chui, Hong Kong (CN); Scot G. Frank, Hong Kong (CN); Grant W. Kristofek, Cambridge, MA (US); Sloan A. Kulper, Hong Kong (CN); Man C. Leung, Hong Kong (CN); Heather Micka-Smith, Lynn, MA (US); Catlin Powers, Hong Kong (CN); Christopher M. Tolles, Boston, MA (US); Liam V. Vleet, Providence, RI (US); Tat L. Wan, Hong Kong (CN); Erica E. Young, Hong Kong (CN)

(21) Appl. No.: 14/389,612

(22) PCT Filed: Mar. 15, 2013
(86) PCT No.: PCT/US2013/031971

§ 371 Date: Sep. 30, 2014

Related U.S. Application Data
(60) Provisional application No. 61/618,042, filed on Mar. 30, 2012.

(51) Int. Cl. G02B 19/00; G02B 26/08; G02B 7/183

(52) U.S. Cl. CPC G02B 19/0042; G02B 19/0019; G02B 7/183; G02B 26/0816
USPC 359/853

(57) ABSTRACT

A portable solar concentrator includes a stand, a plurality of inner panels supported by the stand, and a plurality of outer panels attached to the inner panels. The inner panels have a reflective surface, and are configured to direct solar energy at a target. The outer panels have a reflective surface and can be configured in an active position to direct solar energy at the target, and can be configured in an inactive position to direct solar energy away from the target.

### CROSS REFERENCE TO RELATED APPLICATION

This application claims priority to and the benefit of, and incorporates herein by reference in its entirety, U.S. Provisional Patent Application No. 61/618,042, which was filed on Mar. 30, 2012.

### FIELD OF THE INVENTION

This invention relates generally to portable and collapsible solar concentrator assemblies that can be used for multiple, interchangeable purposes, such as for cooking, generating electricity, or water purification.

### BACKGROUND

People in rural areas may not have ready access to electricity or heat for basic needs, such as for boiling water, cooking food, and staying warm. For instance, in developing nations or indigent areas, access to electricity or heat sources may be limited or nonexistent. Areas with access to abundant solar energy, such as high-altitude, rural areas (e.g., in the Himalayas or Andes), or deserts (Gobi, Sahara, Taklimakan, Sonoran, Mojave, Kalahari, or Atacama), may be able to harness solar energy to provide for these basic needs using this technology. Similarly, developed nations can also benefit from this technology for emergency or disaster relief as well as recreational use and sustainable living.

Current solar concentrators suffer from a number of disadvantages. For example, these devices often use collected solar energy for single-use purposes, such as for either cooking or heating. Such devices merely concentrate or collect solar energy and, therefore, are limited to applications that utilize concentrated or collected solar energy. Furthermore, current devices may not be readily or easily portable. Portability can be desirable for the aforementioned areas, inter alia, due to potentially harsh climates and poor infrastructure.

Currently available devices also rely solely on the amount of solar radiation reaching the surface of the earth to control the cooking temperature. Solar energy users need to be able to exercise control over the temperature supplied by their solar concentrators in order to cook good food or otherwise maximize the efficiency of utilization of solar energy. Further, these concentrators have used mechanical or electrical systems to adjust their solar angle. This has required users to interface with materials that were either physically uncomfortable or difficult for them to operate and maintain. There is a need for a new adjustment system that can be easily operated by a wide range of users, does not cause user discomfort, and can accommodate both manual and automatic tracking. Current solar concentrators also expose users' eyes to harmful radiation and cause musculoskeletal strain among users due to their poor ergonomic design. There is a need for a solar concentrator that minimizes UV-light exposure and musculoskeletal strain for users.

Accordingly, a solar energy system is needed that allows for: (1) a portable and collapsible assembly for easy transport; (2) user controls over temperature/power output of the concentrator; (3) a more comfortable and easily-operated adjustment system that can interface with manual or automatic tracking; and (4) reduction of user exposure to harmful UV radiation and musculoskeletal strain. The components of the system should be cost-effective and lightweight. The system should also be easy to assemble and disassemble. Furthermore, a system that converts the solar energy to other forms may be used for multiple purposes. The system should also allow components for various purposes to be interchangeable without the need for complex assembly or disassembly.

### SUMMARY OF THE INVENTION

In general, in one aspect, the invention relates to a portable solar concentrator including a stand, a plurality of inner panels supported by the stand, and a plurality of outer panels attached to the inner panels. Each inner panel has at least one reflective surface, and the plurality of inner panels is configured to direct solar energy at a target. Each outer panel has at least one reflective surface, and each outer panel can be configured in an active position to direct solar energy at the target, and can be configured in an inactive position to direct solar energy away from the target.

This aspect may have the following features and embodiments. The portable solar concentrator may include a handle disposed in an opening defined by two of the inner panels. Each outer panel may be adjustably attached to an inner panel. Each outer panel may be fixable in one or more positions between the active position and the inactive position. The outer panels may be removable. In certain embodiments, the portable solar concentrator further includes a crossbar supported by the stand, with the plurality of inner panels suspended from the crossbar. The inner panels may be arranged so as to form a parabolic dish. The target may be disposed on the crossbar. The portable solar concentrator may further include a modular stand for supporting the target.

In some embodiments, the portable solar concentrator includes at least one guide attached to the stand, and a control line attached to at least one of the inner panels and threaded through the at least one guide. The angular position of the inner panels may be defined by a position of the control line with respect to the at least one guide. In one embodiment, the solar concentrator further includes a tracking system for at least one of manually and automatically adjusting the position of the control line with respect to the at least one guide.

The above aspect of the invention may also include the following features and embodiments. The portable solar concentrator may include at least five inner panels and at least five outer panels. The portable solar concentrator may further include a shadow-based focusing mechanism. In various embodiments, the portable solar concentrator further includes a braking mechanism for fixing a position of the portable solar concentrator. The braking mechanism may include a brake disc for restricting rotational movement of the portable solar concentrator. At least one of the inner panels and the outer panels may include a rigid frame and a reflective panel removable from the frame.

In another aspect, the invention relates to a method of varying the concentration of solar energy on a target. The method includes the steps of placing the target in a focal area of the reflective dish, orienting the reflective dish substantially toward a source of the solar energy, and adjusting a position of one or more outer panels attached to the perimeter of the reflective dish, such that the one or more outer panels direct solar energy at the target when in an active position and direct solar energy away from the target when in an inactive position.

In one embodiment of the above aspect, orienting the reflective dish includes using a rigging system to adjust a position of a control line coupled to the reflective dish.

These and other objects, along with advantages and features of the present invention herein disclosed, will become apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE FIGURES

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a schematic perspective view of a solar concentrator assembly in accordance with one embodiment of the invention.

FIG. 2 is schematic perspective view of the bottom of the solar concentrator assembly of FIG. 1.

FIG. 3 is a schematic bottom view of the solar concentrator assembly of FIG. 1.

FIG. 4 is a schematic perspective view of the solar concentrator assembly in accordance with an embodiment of the invention.

FIG. 5 is a schematic perspective view of the tripod of the solar concentrator assembly in accordance with an embodiment of the invention.

FIG. 6 is another schematic perspective view of the tripod of FIG. 5.

FIG. 7 is a schematic perspective view of the top tripod connector of the tripod of the solar concentrator assembly in accordance with an embodiment of the invention.

FIG. 8 is another schematic perspective view of the bottom of the top tripod connector of FIG. 7.

FIG. 9 is a schematic side view of the top tripod connector of FIG. 7.

FIG. 10 is a schematic perspective view of the bottom tripod connector of the tripod of the solar concentrator assembly in accordance with an embodiment of the invention.

FIG. 11 is a schematic side view of the bottom tripod connector of FIG. 10.

FIG. 12 is a schematic perspective view of a portion of the base of the solar concentrator assembly in accordance with an embodiment of the invention.

FIG. 13 is a schematic side view of the portion of the base of FIG. 12.

FIG. 14 is a schematic perspective view of a portion of the base of the solar concentrator assembly, including the extension, bottom support structure, and rod, in accordance with an embodiment of the invention.

FIG. 15 is a schematic side view of the extension, bottom support structure, and rod of FIG. 14.

FIG. 16 is a schematic perspective view of the bottom support structure of the base of the solar concentrator assembly in accordance with an embodiment of the invention.

FIG. 17 is a schematic side view of the bottom support structure of FIG. 16.

FIG. 18 is a schematic perspective view of a top support structure of the base of the solar concentrator assembly in accordance with an embodiment of the invention.

FIG. 19 is a schematic side view of the top support structure of FIG. 18.

FIG. 20 is a schematic perspective of a cap and top support structure of the base of the solar concentrator assembly in accordance with an embodiment of the invention.

FIG. 21 is a schematic front view of the cap and top support structure of FIG. 20.

FIG. 22 is a schematic perspective view of the cap of the base of the solar concentrator assembly in accordance with an embodiment of the invention.

FIG. 23 is a schematic side view of a thermoelectric module in accordance with an embodiment of the invention.

FIG. 24 is a schematic cross-sectional view of the thermoelectric module of FIG. 23.

FIG. 25 is a schematic exploded view of the thermoelectric module of FIG. 23, without the heat sink.

FIG. 26 is a schematic side view of a thermoelectric module in accordance with an embodiment of the invention.

FIG. 27 is a schematic exploded view of a portion of the thermoelectric module in accordance with an embodiment of the invention.

FIG. 28 is a schematic perspective of a heat sink and a water-retaining vessel of a thermoelectric module in accordance with an embodiment of the invention.

FIG. 29 is a schematic perspective and partial cross-sectional view of a heat transfer module in accordance with an embodiment of the invention.

FIG. 30 is a schematic perspective view of a solar concentrator assembly in accordance with an embodiment of the invention.

FIG. 31 is a schematic top view of a solar concentrator assembly in accordance with an embodiment of the invention.

FIG. 32 is a schematic side view of a solar concentrator assembly in accordance with an embodiment of the invention.

FIG. 33 is a schematic partial side view of a rigid panel in accordance with an embodiment of the invention.

FIG. 34 is a schematic perspective view of a curved support member in accordance with an embodiment of the invention.

FIG. 35 is a schematic perspective partial view of a distal end of a curved support member in accordance with an embodiment of the invention.

FIG. 36 is a schematic perspective view of a stand and a pot stand in accordance with an embodiment of the invention.

FIG. 37 is a schematic perspective view of a solar concentrator assembly in accordance with an embodiment of the invention.

FIG. 38 is a schematic perspective partial view of a hanging assembly in accordance with an embodiment of the invention.

FIG. 39a is a schematic top view of a stand and a pot stand in accordance with an embodiment of the invention.

FIG. 39b is a schematic perspective view of a pot stand in accordance with an embodiment of the invention.

FIG. 39c is a schematic end view of a hanging shaft in accordance with an embodiment of the invention.

FIG. 40 is a schematic perspective exploded view of a vertical support assembly in accordance with an embodiment of the invention.

FIG. 41 is a schematic front view of a vertical support assembly in accordance with an embodiment of the invention.

FIG. 42 is a schematic front view of a leg tube and legs in accordance with an embodiment of the invention.

FIG. 43 is a schematic top view of a leg tube and legs in accordance with an embodiment of the invention.

FIG. 44 is a schematic perspective view of a staking assembly in accordance with an embodiment of the invention.

FIG. 45 is a schematic perspective view of a solar concentrator assembly in accordance with an embodiment of the invention.

FIG. 46 is a schematic perspective view of the solar concentrator assembly of FIG. 45.

FIG. 47 is a schematic perspective view of the solar concentrator of assembly FIG. 45.

FIG. 48 is a schematic perspective view of the solar concentrator of assembly FIG. 45.

FIG. 49 is a schematic perspective view of a solar concentrator assembly in accordance with an embodiment of the invention.

FIG. 50 is a schematic perspective view of a solar concentrator assembly with a rigging system in accordance with an embodiment of the invention.

FIGS. 51a-51b are schematic side views showing the operation of a rigging system in accordance with an embodiment of the invention.

FIGS. 52a-52b are schematic side views showing the operation of a rigging system in accordance with an embodiment of the invention.

FIGS. 53a-53b are schematic side views showing the operation of a rigging system in accordance with an embodiment of the invention.

FIGS. 54a-54b are schematic side views showing the operation of a rigging system in accordance with an embodiment of the invention.

FIG. 55a-55b are schematic perspective views of a modular stand in accordance with various embodiments of the invention.

FIG. 56a-56b are schematic perspective views illustrating a removable reflector panel in accordance with an embodiment of the invention.

FIG. 57 includes schematic perspective views of a braking mechanism in accordance with various embodiments of the invention.

### DETAILED DESCRIPTION

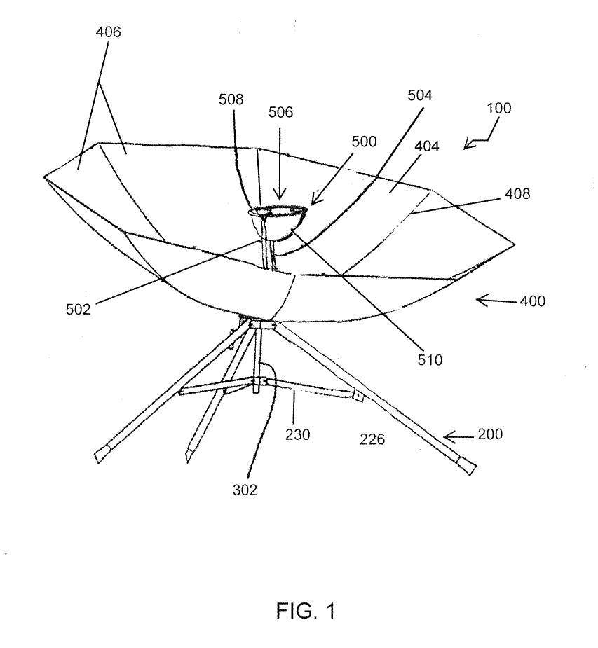

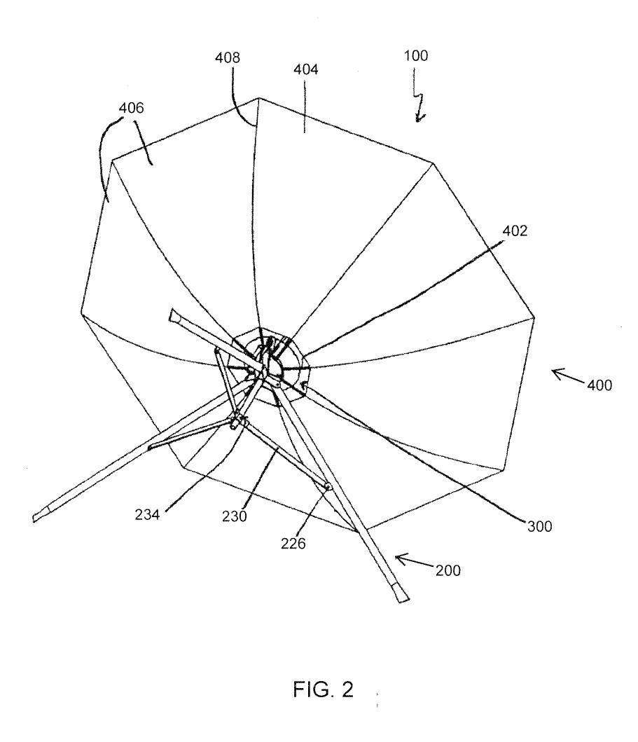

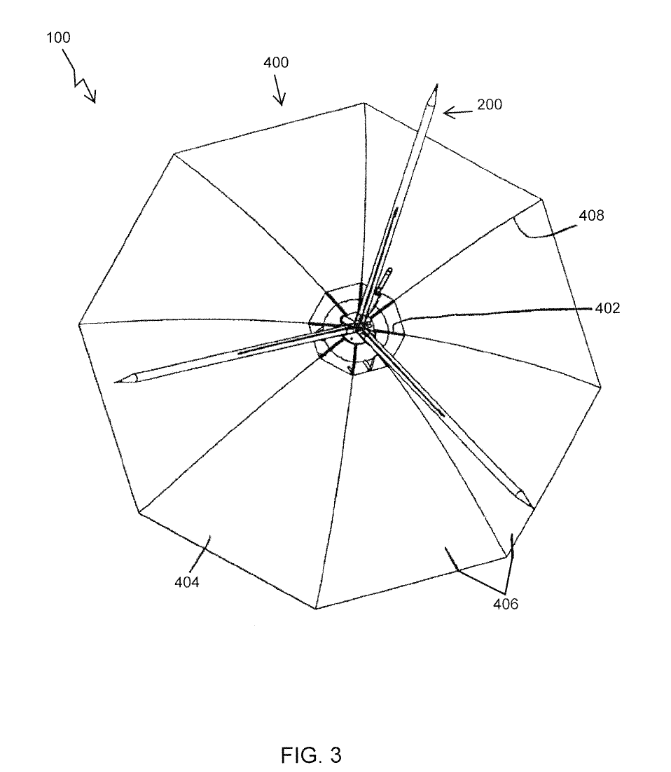

FIGS. 1 through 4 depict various views of embodiments of a solar concentrator assembly 100. The solar concentrator assembly 100 has various modules. These include a tripod module 200, a base module 300, and a reflective dish module 400. These modules may be manufactured and designed to be lightweight, portable, and easily assembled and disassembled. For example, various components of the modules may be made from lightweight, yet sturdy materials, such as sheet metal (e.g., aluminum), bamboo, plastics, textiles, and/or canvas. Moreover, the tripod module 200 and the reflective dish module 400 may be collapsible or foldable.

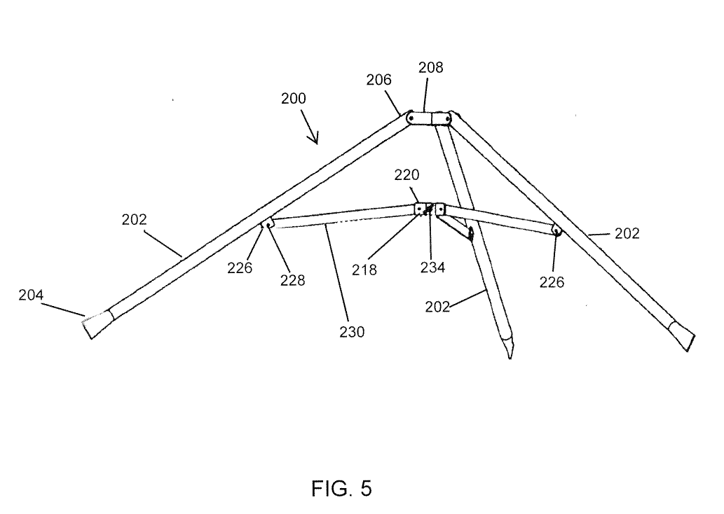

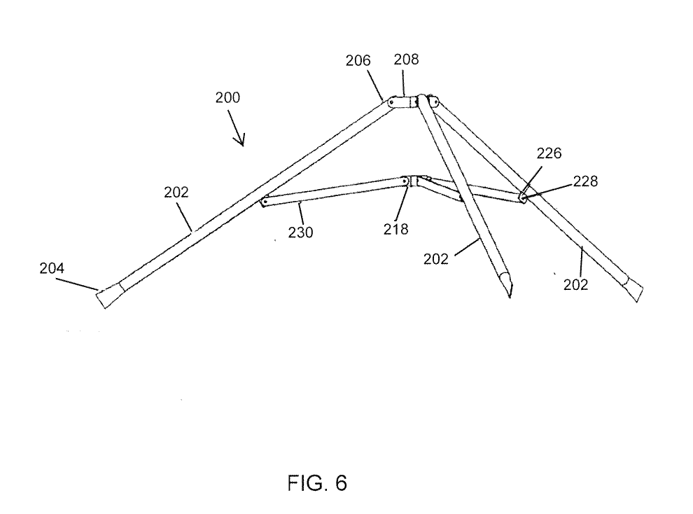

FIGS. 5 and 6 depict various views of an embodiment of the tripod module 200. The tripod module 200 includes a plurality of legs 202, for example, three legs, to provide a stable base. Additionally, the tripod 200 may have more legs than shown. Each of the legs 202 has a ground-engaging end 204 and a top end 206. The ground-engaging end 204 of the legs 202 may be pointed, flattened, or sharpened to allow the tripod 200 and solar concentrator assembly 100 to engage and to grab a hold of the ground. This provides for a stable engagement with the ground while minimizing slippage. Other shapes, sizes, and orientations of the ends are contemplated (e.g., tapered ends, slightly hollow interior with tapered or pointed ends, and pointed steel caps) that allow for the tripod 200 to engage the ground while minimizing slippage in order to provide a stable foundation for the tripod 200 and the solar concentrator assembly 100. Rope loops may also be attached to the legs 202 to allow the tripod and solar concentrator assembly to be staked down. The solar concentrator assembly may also be staked down by driving a stake through a hole in a leg 202.

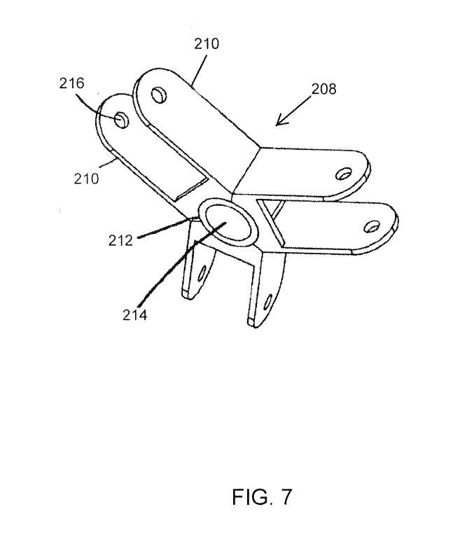

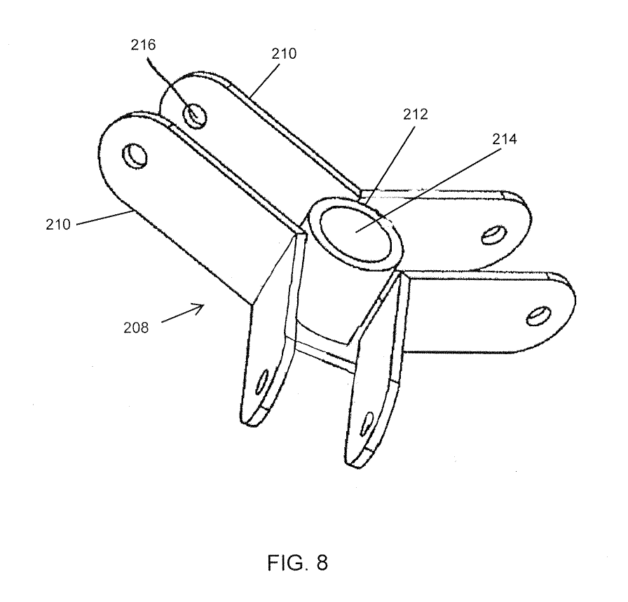

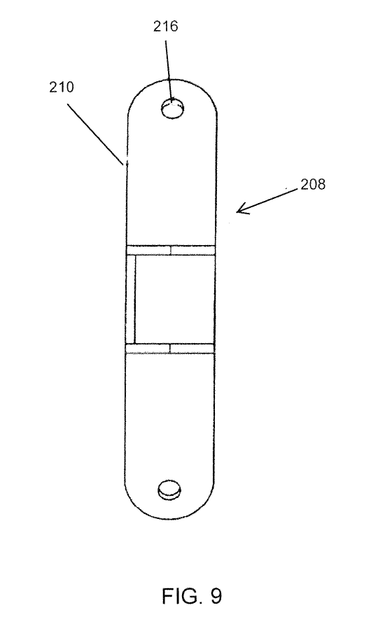

FIGS. 7 through 9 depict various views of an embodiment of a top tripod connector 208. The top tripod connector 208 connects all of the legs 202 together at their top ends 206. The top tripod connector 208 includes arms 210 extending from a central body 212 with an aperture 214 formed vertically through the central body 212. The number of arms 210 may be twice the number of legs 202. The arms 210 may be paired and sized such that the distance between the arms 210 is substantially the same size, and perhaps slightly larger, than the diameter or width of the top ends 206 of the legs 202. In this manner, the top ends 206 of the legs 202 may fit between the arms 210. The legs 202 may be secured to the arms 210 of the top tripod connector 208 via bolts. Apertures 216 formed in the arms 210 and the legs 202 (not shown) receive the bolts therethrough. The legs 202 are pivotably secured to the arms 210, while bolted, so that the legs 202 may move and allow the assembled tripod 200 to fold or collapse.

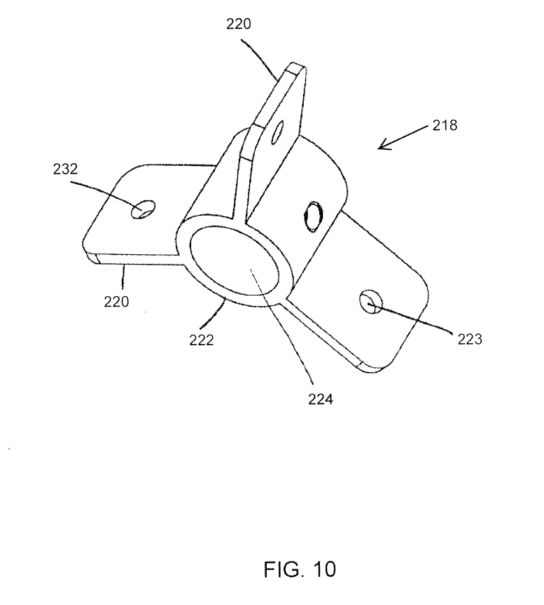

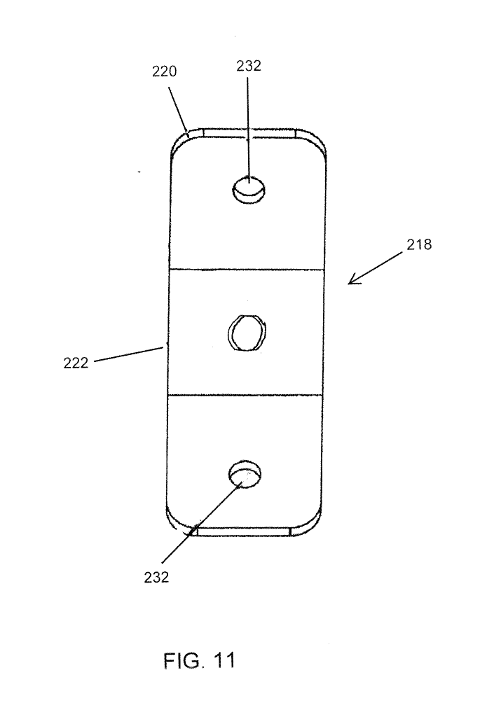

FIGS. 10 through 11 depict various views of an embodiment of a bottom tripod connector 218. The bottom tripod connector 218 includes wings 220, one for each leg 202, extending from a substantially cylindrical body 222 with a hollow portion 224 formed therethrough. Referring back to FIGS. 1, 2, 5, and 6, each leg 202 is connected to a bracket 226. The bracket 226 may be integrally formed with the leg 202, or connected to the leg 202 through various mechanisms, including, but not limited to, welding, gluing, screwing, or bolting. Each bracket 226 includes an aperture 228 to connect to an elongate extension 230. The elongate extension 230 is connected to a wing 220 and a bracket 226, for example, by bolting through apertures 232 on the wings 220 and apertures 228 on the brackets 226. The elongate extension 230 is pivotably connected such that the legs 202 may be collapsed or folded. The elongate extensions 230 may have varying lengths such that the length of the elongate extensions 230 determines how far apart the legs 202 spread. Alternatively, the bottom tripod connector 218 may have a similar shape as and may be correspondingly similarly secured to the legs 202. In this embodiment, the bottom tripod connector 218 may have dimensions larger or smaller than the top tripod connector 208.

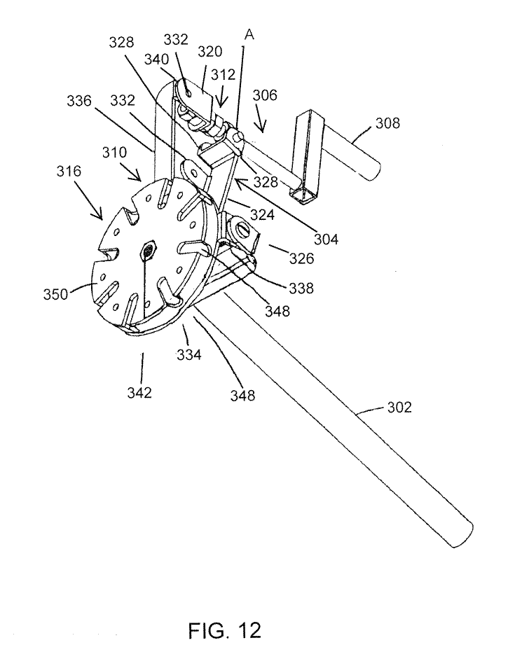

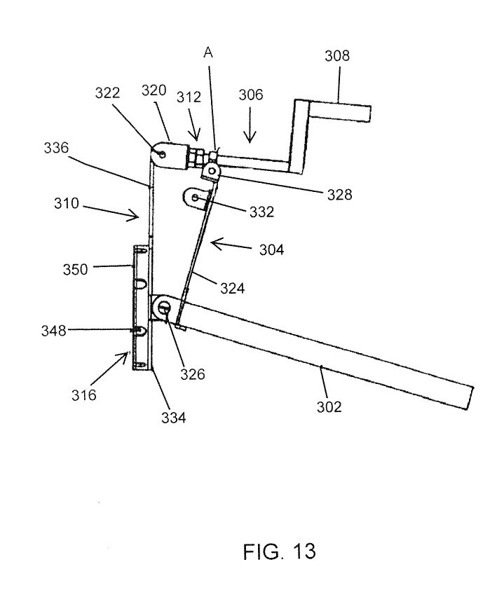

FIGS. 12 through 13 depict various views of an embodiment of a base module 300. The base module 300 includes a rod 302 connected to one end of a base assembly bottom support structure 304. The rod 302 may be integrally formed with the bottom support structure 304 or the rod 302 may be fixed securely to the bottom support structure 304 through various means, including with epoxy, welding, adhesive, screws, etc. The rod 302 and bottom support structure 304 may be fixed together such that they move together. Alternatively, the rod 302 and bottom support structure 304 may be pivotably connected to one another. The end opposite the rod-connecting end of the bottom support structure 304 is connected to an extension 306, which may be, for example, a leadscrew. The extension 306 includes a handle 308 at one end. The bottom support structure 304 may be connected to the extension 306 at any point near the end distal to the handle 308. The bottom support structure 304 may be fixed to the extension 306. Alternatively, the bottom support structure 304 is pivotably connected (e.g., via a bolt) to the extension 306. In another alternative embodiment, the rod 302 may be inserted in a short length of pipe that is welded or connected to the bottom support structure 304. Such a degree of freedom could then be fixed using a set screw or clamp. A base assembly top support structure 310 is connected near the end distal to the handle 308 end of the extension 306. The opposite end of the top support structure 310 is pivotably mounted on top of the bottom support structure 310. The top support structure 310 may be mounted (e.g., via bolts or screws) on top of the bottom support structure 304 where the rod 302 is located. The extension 306 may include the handle 308 and a hand cranked threaded screw 312. Operation of the handle 308, such as clock-wise or counterclock-wise movement, will lengthen or shorten the extension 306. Lengthening or shortening the extension 306 tilts the top support structure 310 relative to the bottom support structure 304. A cap 316 is mounted on top of the top support structure 310. In an embodiment, the cap 316 may be screwed, bolted, or attached through various fixed means to the top support structure 310.

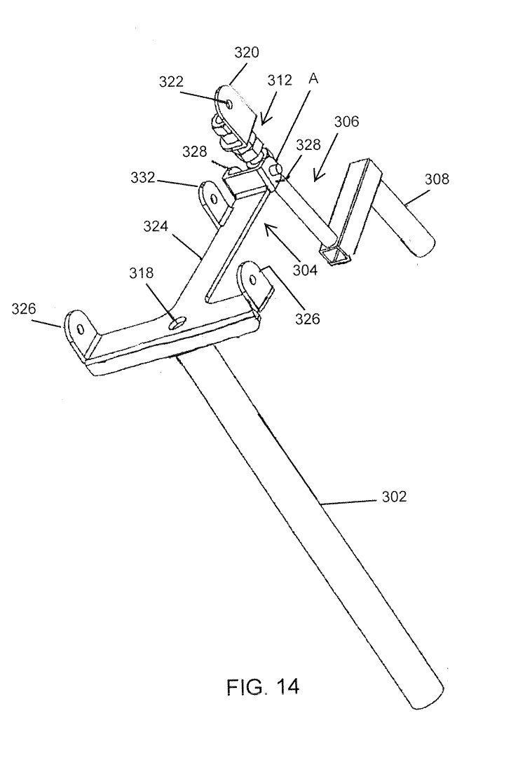

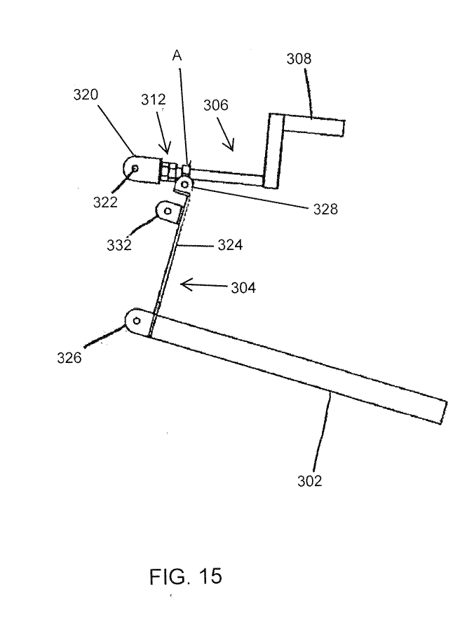

FIGS. 14 and 15 depict various views of the rod 302 connected to the bottom of the top support structure 310, which is connected to the extension 308. Further, as described hereinabove, the rod 302 is attached to the bottom support structure 304. As shown in FIG. 14, the bottom support structure 304 may include a hole 318 so that the rod 302 may be attached to the bottom support structure 304, for example, with a screw, bolt, or nut. A cross-section of the rod may correspond in shape to the aperture 214 of the central body 212 of the top tripod connector 208 and the hollow portion 224 of the cylindrical body 222 of the bottom tripod connector 218. For example, the shape of the rod 302 may be substantially cylindrical. The extension 306 may be connected to the bottom support structure 304 at point A through various means, including by pin, bolt, or screw. The handle 308 of the extension 306 may have a linear or non-linear shape. For example, the handle 308 may have a substantially S-shaped configuration so that a user may leverage the handle 308 for operation. The portion of the extension 306 distal to the handle, past point A, may be a threaded screw 312. Additionally, point A of the extension 306 is fixed relative to the bottom support structure 304, such that point A does not move during operation of the handle 308. An elongate bracket 320 is attached near and past the end of the extension 306 distal the handle 308 end. The elongate bracket 320 includes an aperture 322 to connect (e.g., with a bolt or screw) to the top support structure 310.

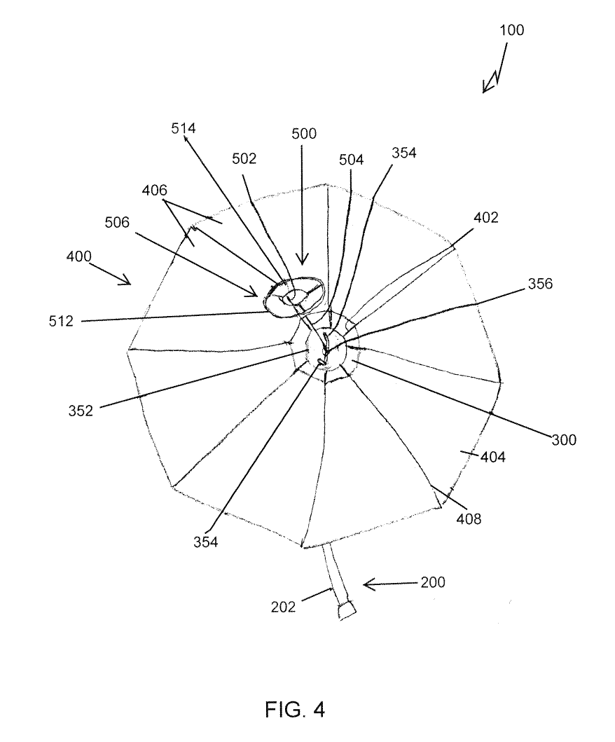

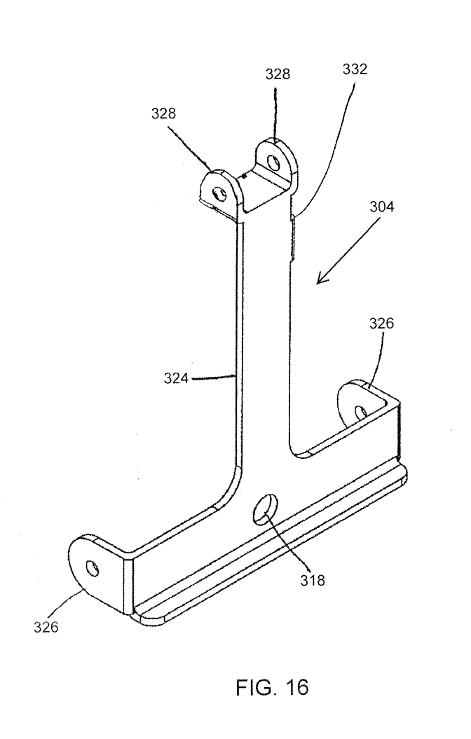

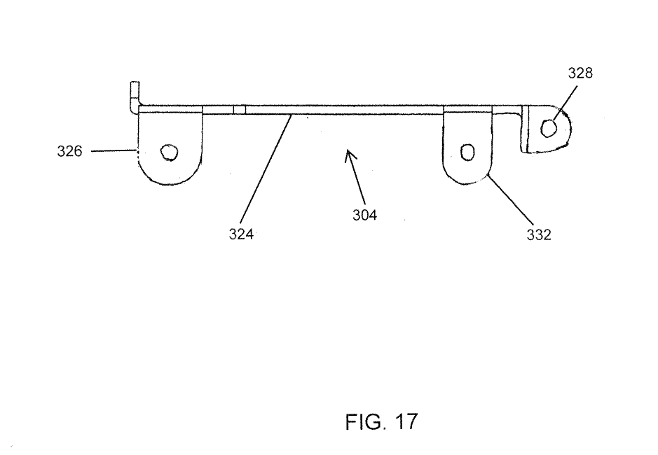

FIGS. 16 and 17 depict various views of an embodiment of the bottom support structure 304. The bottom support structure 304 may have a substantially T-shaped configuration. The bottom support structure 304 includes a base surface 324 with projections 326 extending perpendicularly from the base surface 324. At the wide end of the bottom support structure, two projections 326 that extend perpendicularly from the base surface 324 engage similar projections from the top support structure 310 to connect pivotally therebetween. Additionally, the two projections 326 are bolted to corresponding projections from the top support structure 310, such that the top support structure 310 can pivot and tilt relative to the bottom support structure 304. Two side prongs 328 project away from the bottom support structure 304. The two side prongs 328 connect to the extension 306 and include apertures 330 in each so that a pin, bolt, or screw can attach the bottom support structure 304 to the extension 306, as described hereinabove. A third projection 332 extends perpendicularly from the base surface of the bottom support structure, similar to the first two projections 326. This third projection 332 engages with a receptacle 500, as shown in FIGS. 1 and 4 and discussed further hereinbelow. The bottom support structure 304 may be unitary. Other shapes or configurations of the bottom support structure 304 are contemplated (e.g., substantially rectangular or substantially square-shaped). Alternatively, the shape of the bottom support structure 304 may be substantially similar to the shape of the top support structure 310. Further, the bottom support structure 304 and/or the top support structure 310 each may be made by cutting the entire structure out of a flat sheet and bending them into shape, or welding together pieces of metal strips, or a combination of the two methods.

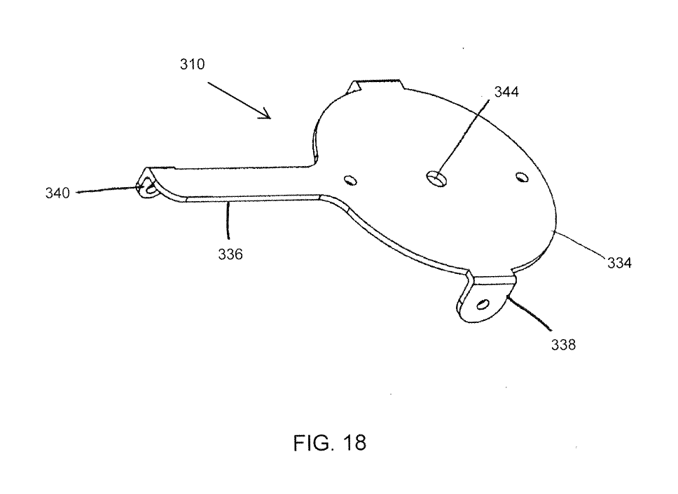

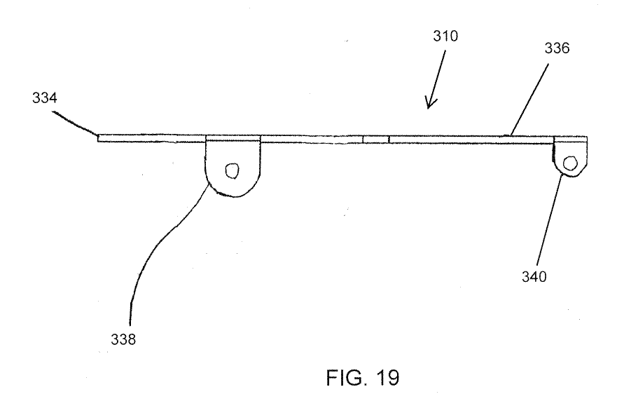

FIGS. 18 and 19 depict various views of an embodiment of the top support structure 310. The top support structure may have a substantially pan-like shape, with a substantially circular head 334 and an elongate handle 336. The top support structure 310 includes a flat base with multiple projections 338, 340 extending perpendicularly therefrom. Two projections 338 are formed on opposite sides of the substantially circular head 334. These two projections 338 correspond and pivotally connect to projections 326 on the bottom support structure 304, as described hereinabove. A third projection 340 at the elongate handle 336 end of the top support structure 310 pivotably connects to the extension 306, also as described hereinabove. The top support structure 310 may be unitary. Other shapes or configurations of the top support structure 310 are contemplated (e.g., substantially rectangular or substantially square-shaped).

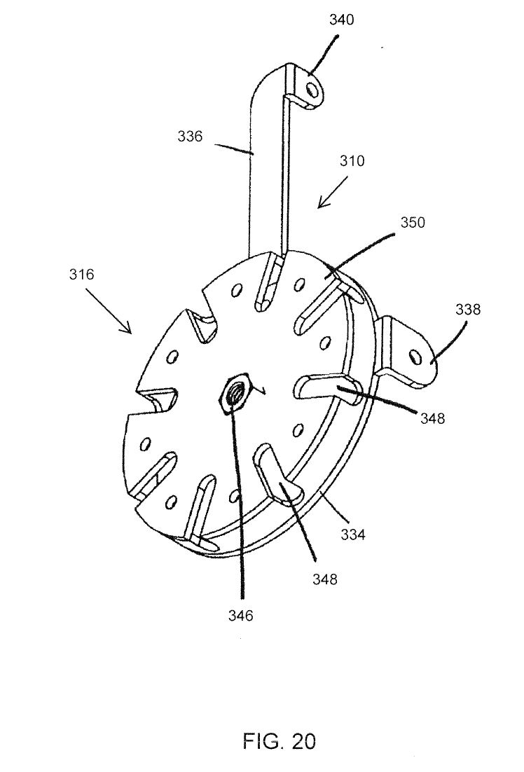

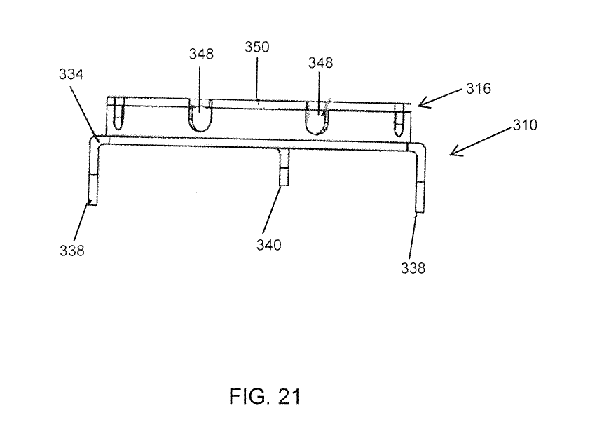

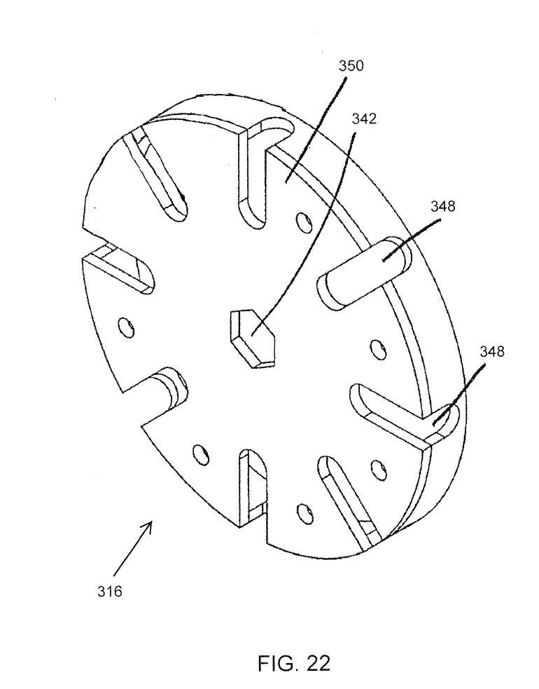

FIGS. 20 through 22 depict various views of an embodiment of the cap 316 mounted on top of the top support structure 310. FIG. 22 depicts an embodiment of the cap 316. The cap 316 is substantially circular and substantially identical in size and shape to the substantially circular head 334 of the top support structure 310. The cap 316 may have the same diameter as the substantially circular head 314 of the top support structure 310, absent the projections 338 on the sides of the substantially circular head 334. Alternatively, the cap 316 may have a diameter larger or smaller than substantially circular head 334 of the top support structure 310. The cap 316 is mounted on top of the top support structure 310. An aperture 342 formed about the center of the cap 316 aligns with an aperture 344 about the center of the substantially circular head 334 of the top support structure 310. The cap 316 may be affixed to the top support structure 310 via a threaded screw 346 through apertures 342, 344. Elongate notches 348 are also disposed about the perimeter of the cap 316, each corresponding to a dish support rod 402. The elongate notches 348 may be substantially evenly spaced about the perimeter of the cap 316. Additionally, the opening of the elongate notches 348 may extend down the side of the cap 316 without extending all the way to and through the bottom side of the cap 316. Alternatively, the elongate notches 348 do extend all the way to and through the bottom side of the cap 316. In an embodiment, the top surface 350 of the cap 316 may be removable. The top surface 350 of the cap 316 may be attached through various removable means, including with screws, nails, or a snap-fit connection.

Referring back, FIG. 4 depicts an embodiment of the solar concentrator assembly 100 with a compression plate 352. The compression plate 352 may be substantially the same size and shape as the cap 316. Alternatively, the compression plate 352 may be larger than the cap 316. For example, the diameter of the compression plate 352 may be about twice the diameter of the cap 316. Additionally or alternatively, the compression 352 plate includes a lip, e.g., disposed about and/or along the circumference, for added rigidity and to provide deeper compression. The compression plate 352 includes handles 354 and a compression crank 356, a threaded rod, about the center of the compression plate 352. Operation of the compression crank 356 secures and tightens the compression plate 352 to the cap 316. The compression crank 356 may be a wing nut. The handles 354 may be secured to the compression plate 352 through various means, including via welding, screws, and adhesive. Alternatively, the handles 354 form a unitary structure with the compression plate 352.

Referring back, FIGS. 1 through 4 depict various views of an embodiment of the reflective dish module 400. The reflective dish module includes multiple dish support rods 402 and a pliable material 404. The pliable material 404 includes multiple panels 406 corresponding to an equal number of dish support rods 402. The panels 406 may be formed by sewing them together, or by any other means, which forms seams 408 therebetween. The pliable material 404 may be a sturdy cloth, fabric (e.g., yak hair or wool canvas, ripstop fabric), or plastic. A light and flexible reflective material layer (not shown) is disposed on top of the sturdy cloth, fabric, or plastic. The light and flexible reflective material may be disposed on the sturdy cloth, fabric, or plastic in a variety of manners (e.g., sewing or using adhesive). The light and flexible reflective material may be an aluminized plastic polymer, MYLAR®, polyethylene terephylalate, recycled chip bags, reflective food packaging, metal foil, aluminum foil, or mesh network of small glass mirrors. The dish itself may also be asymmetric, where not all the panels 406 are of equal size and certain panels 406 are made larger to take advantage of solar incident angle.

In one embodiment, the panels 406 include a flexible layer of plastic, fabric, woven textile, non-woven textile, ripstop fabric, and/or canvas. A reflective coating or layer may be applied to the flexible layer using various methods. For example, the flexible layer may be metalized using vacuum deposition, electroplated using a transparent conductive layer, laminated or glued to a metalized MYLAR® (PET) film, and/or sewn to a metalized MYLAR® (PET) film. In addition, the flexible layer may be supported by a fabric backing, a semi-rigid plastic sheet, and/or a fiberglass or metal (e.g., aluminum) skeleton.

The dish support rods 402 may be sturdy, yet flexible. For example, the dish support rods 402 may be made of bamboo, fiberglass, metal, or plastic. In assembling the reflector dish module 400, the dish support rods 402 are inserted into the seams 408 between each of the panels 406. The other ends of the dish support rods 402 are inserted into the elongate notches 348 in the cap 316 of the base module 300 so that the dish support rods 402 are radially protruding therefrom. Additionally, a single cable (not shown) may be threaded through a small hole at the end of each rod 402. The cable connects the rods 402 together. The ends of the rods 402 and cable may be housed in the cap 316. The sturdy cloth or fabric may not cover all of the dish support rods 402 when they are inserted into the elongated notches 348 of the cap 316. Or the reflective dish may be attached or clipped to the rods 402 with plastic or metal clips. In this arrangement, a cloth sleeve may not be used. Alternatively, the sturdy cloth or fabric covers substantially all of the dish support rods 402 when they are inserted into the elongated notches 348 of the cap 316. The rods 402 may also be inserted into sleeves or runners made from, for example, canvas, nylon, or neoprene that separate each panel 406. Once the rods 402 are inserted into the seams 408 of the sturdy cloth or fabric and the elongated notches 348 of the cap 316, the compression plate 352 may be placed over the cap 316. Adjusting the compression crank 356 of the compression plate 352 tightens the compression plate 352 against the cap 316, which tensions the portion of the dish support rods 402 disposed in the base module 300. Tensioning the dish support rods 402 creates the rigid, substantially parabloid shape of the reflector dish. Setting up the reflector dish module 400 in this manner allows a single person to assemble or dissemble the entire reflector dish module 400 quickly and efficiently. In another embodiment, the dish support rods 402 are pre-bent, which may remove the need compression plate 352 and/or compression crank 356.

The shape of the assembled reflector dish module 400 may take the form of any parabola-type shape. For example, the shape may include a uniform parabola or a compound parabola, in which certain sections or portions of the assembled reflector dish module 400 are substantially parabloid and other remaining sections or portions may take the form of any geometric shape. In various embodiments, the reflector dish module 400 may be adjustable such that a user may manipulate various portions or sections to form a uniform parabola or a compound parabola shape. In these configurations, the user may control the shape of the reflector dish module 400 to control the concentration, collection, and direction of solar energy. For example, portions of the dish support rods 402, pliable material 404, panels 406, and seams 408 may be flexible and/or adjustable to allow a user to change the shape of the reflector dish module 400 among any type of parabola-shape.

In one embodiment, to assemble the solar concentrator assembly 100, the tripod module 200 is unfolded such that the legs 202 are spread to provide a foundation and placed on the ground. The rod 302 of the base module 300 may be received by the center apertures 214, 224 in the top tripod connector 208 and bottom tripod connector 218 of the tripod module 200. The rod 302 may be lowered to at least as low as the bottom support structure 304 of the base module 300 contacting the top tripod connector 208 of the tripod module 200. The rod 302 may be affixed to the tripod module 200 by an adjustable screw 234 (e.g., a thumb screw or wing nut) that is threaded from the bottom tripod connector 218. Because the adjustable screw 234 is manually operable, the user may rotate and pan the base module 300 about the vertical axis. Furthermore, as described hereinabove, the reflector dish module 400 may be constructed by inserting the dish support rods 402 into seams 408 of a sturdy cloth or fabric and placing the other ends of the dish support rods 402 into elongated notches 348 in the cap 316 of the base module 300. This step in the assembly may not be necessary each time the solar concentrator assembly 100 is set up. For example, the solar concentrator assembly 100 may be folded with the dish support rods 402 inserted in the elongate notches 348. The user may operate the compression crank 356 to tighten the compression plate 352 to the cap 316 and to tension the dish support rods 402 to form the substantially parabloid shape or compound parabloid of the reflective dish 400. The user may manipulate the hand cranked threaded screw 312 of the extension 306 to control the tilt of the reflector dish 400. Accordingly, by controlling the tilt of the reflector dish module 400 and the pan of the base module 300 and reflector dish module 400, the user can move the reflector dish 400 about any arbitrary trajectory.

Once the reflector dish 400, base 300, and tripod 200 modules are assembled, a receptacle 500 may be affixed to the base module 300. Referring back, FIG. 1 depicts an embodiment of the receptacle 500. The structure of the receptacle 500 may include a four bar linkage system, where the base module 300 is the bottom linkage. In this configuration, the receptacle 500 and the contents therein may remain level throughout tilt adjustment of the reflector dish module 400. One side bar 502 of the four bar linkage connects to (e.g., via a bolt, screw, etc.) the third projection 332 from the bottom support structure 304 through the opening between the sturdy cloth or fabric and the cap 316 and compression plate 352. The other side bar 504 of the four bar linkage connects to the compression plate 316. The top part 506 of the four bar linkage may be disposed within the concave part of the reflector dish module 400 and may form any structure that receives an apparatus, such as a pot. For instance, FIG. 1 depicts the top linkage 506 of the receptacle 500 as a frame 508 with a concave, semi-circular link 510 to support the frame 508. The frame 508 may be a circle or it may be any other geometric shape. Alternatively, FIG. 4 depicts two concentric circles or rings 512, 514 connected together by additional links or by an outer circle with links that point towards the center, but are not connected to a second inner circle. In both embodiments, an apparatus, such as a pot, may fit into the top part 506 of the four bar linkage. Alternatively, the top linkage 506 may form any structure that will receive an apparatus, such as a pot. For example, the top linkage 506 may form an open semi-circle or concave shape adapted to receive a pot.

The assembled solar concentrator assembly 100 may harness solar energy for various purposes. By way of example only, additional, interchangeable modules may allow a user to generate electricity, cook food, and generate heat.

Referring again to FIGS. 1-4, the seams 408 of the reflective dish module 400 may include elastic strips to support the dish support rods 402. In this case, the panels 406 are separated by the elastic strips rather than being attached directly to each other. The elastic strips may help to evenly distribute forces across the panels 406. For example, the elastic strips may provide tension along the dish support rods 402 and/or between the panels 406. Use of the elastic strips provides enough tension to the panels 406 so that they are held in the proper position without being deformed.

In another embodiment, the reflective dish module 400 may include clips to hold the pliable material 404 to a central support rib hub, such as the cap 316, the compression plate 352, and/or the top surface 350. Clips may also be used to secure the pliable material 404 to the outer ends of the dish support rods 402.

To assemble the reflective dish module using the clips, in one embodiment, a user first inserts the dish support rods 402 into the support rib hub. The dish support rods 402, which may be curved or pre-bent and made of metal (e.g., aluminum), are inserted so that they are curved in the same direction. The user may then place the attached dish support rods 402 on the ground so that the dish support rods 402 point downward and the support rib hub is supported in the air. The user may then unfold the pliable material and grasp it by a center portion, such as a center hole. The user may then clip the pliable material to the support rib hub. Specifically, the user may attach hooks or clips near the center hole of the pliable material to corresponding clips or hooks on the support rib hub. Next, the user chooses a single dish support rod 402 and attaches the outer edge of the dish support rod 402 to a corresponding outer edge clip on the pliable material 404. As seen from above, if the first outer edge clip were placed at six o'clock, a second outer edge clip located at 12 o'clock may be secured to its corresponding dish support rod 402. A third outer edge clip located at three o'clock may be secured next, followed by a fourth outer edge clip located at nine o'clock. The remaining outer edge clips may be attached to the remaining dish support rods 402 in any order.

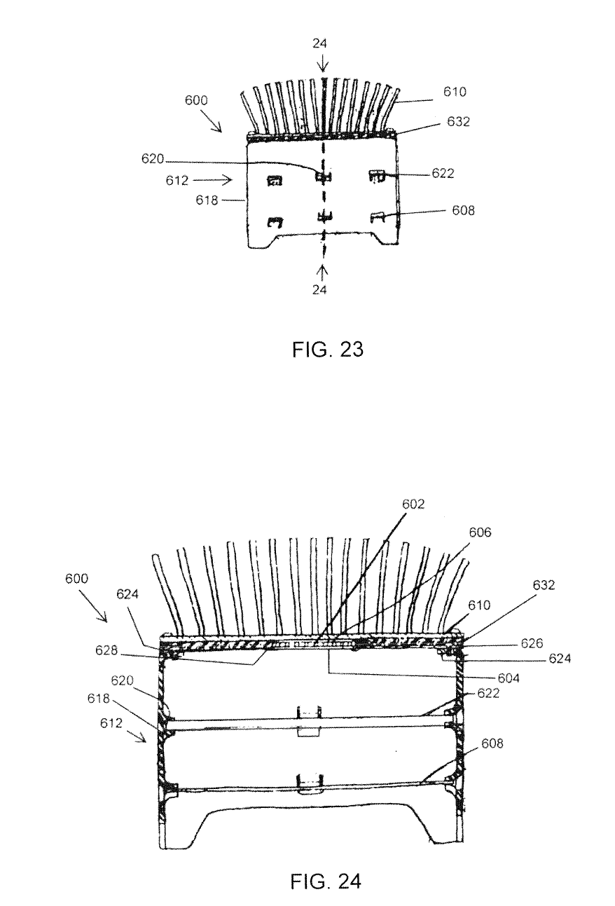

FIGS. 23 through 26 depict various views and embodiments of a thermoelectric module 600. A thermoelectric module 600 may be placed in the top linkage 506 of the receptacle to generate electricity. The electricity may be used for various purposes, including charging batteries, lighting, and charging and powering electric devices. In addition or as an alternative to generating electricity, the thermoelectric module 600 and the solar concentrator assembly 100 may heat or boil water.

The thermoelectric module 600 may utilize at least one thermopile or any other thermoelectric device 602 that converts thermal energy to electrical energy. Thermopiles generate electricity from a temperature gradient across their surface. An example of a thermopile includes, but is not limited to, bismuth telluride thermopile (available from Everred Technology Co., Ltd., Shenzhen, China), which has a high ratio of electrical conductivity to thermal conductivity at temperatures in the range of 50-200° C. The temperature gradient is the temperature difference between the bottom 604 and top 606 sides of the thermoelectric device 602. The bottom side 604 is the hot side of the device, insofar as thermal energy is directed to the bottom side 604 by the solar concentrator assembly 100. The top side 606 is the cold side of the device, insofar as the top side 606 may be exposed to ambient air, which may be cold, or may be cooled through various mechanisms.

Additionally, the temperature of the hot side 604 of the thermoelectric device 600 may be enhanced to accentuate the temperature gradient. For example, solar energy may be concentrated and focused on to the bottom side via a Fresnel lens 608. Various lenses may be used with desirable characteristics, such as compactness, low-cost, and durability. The hot side 604 may also be enclosed completely by the body of the thermoelectric device 602 and a glass panel to eliminate convective losses.

Additionally or alternatively, the cold side 606 of the thermoelectric device 600 may be similarly enhanced to accentuate the temperature gradient. The cold side 606 may be enhanced with various methods. For example, a heat sink 610 may be mounted to and/or on top of the cold side 606. The heat sink 610 draws heat away from the cold side 606 of the thermoelectric device 602, thereby making the surface cooler. For example, FIGS. 24 through 26 depict various views and embodiments of a thermoelectric module 600 with an enhanced hot side 604 and an enhanced cold side 606. In particular, in one embodiment, a Fresnel lens 608 is used to enhance the hot side 604 of the thermoelectric device and a heat sink 610 is used to enhance the cold side 606 of the thermoelectric device 602. The thermoelectric module 600 may include a main body 612 with four side walls 614, 616 defining an interior space and an open bottom. At least one side wall 616 may be removable from the remaining three side walls 614, which may be formed from one integral structure. The removable side wall 616 may be affixed to the remaining three side walls 614 through various means, including with screws, adhesive, rivets, or nails. Each of the side walls 614, 616 may include multiple retaining projections 618, 620 protruding from the side walls 614, 616. The retaining projections 618, 620 may be formed on two levels of the side walls, one higher than the other. Each of the levels for the retaining projections 618, 620 may hold or retain a plate, such as a glass plate 622 and/or a Fresnel lens 608. For example, the glass plate 622 may be retained at a level higher than the Fresnel lens 608. Because the bottom of the main body may be open and the main body 612 is disposed within the concave part of the reflector dish 400, solar energy may be directed to the Fresnel lens 608, which then concentrates and directs energy to the bottom side 604 of the thermoelectric device 602. Additionally, the retaining projections 618, 620 may all be oriented in the same direction (not shown). For example, all of the retaining projections 618, 620 may project upwards or downwards. Alternatively, with respect to each level of the retaining projections 618, 620, the orientation of the retaining projections 618, 620 may be asymmetrical in that at least one retaining projection may project upward 618 and at least one retaining projection may project downward 620. In this manner, plates 608, 622 that are slid and placed onto or between the retaining projections 618, 620 may have a secure fit. The retaining projections 618, 620 may be integrally formed with the side walls 614, 616. Alternatively, the retaining projections 618, 620 are affixed to the side walls through various means, including with adhesive, screws, rivets, and nails. Moreover, the retaining projections 618, 620 may be an elongate element spanning substantially the length of each side wall 614, 616 (not shown). The elongate element may be integrally formed with a side wall 614, 616 or may be affixed to a side wall 614, 616 through the aforementioned various means.

In another embodiment, the top of the main body 612 is generally open, with the exception of a portion of the top 604 that contacts and is affixed to a thermoelectric module retaining plate 626. The portion of the top 624 that contacts the thermoelectric module retaining plate 626 may be a protuberance 624 that projects into the open interior space. There are four protuberances 624 shown in FIG. 25, but the main body 612 may have fewer or more of the protuberances 624 than shown. The thermoelectric module retaining plate 626 forms an interior aperture or recess that corresponds in shape and fits with a thermoelectric device 602, such as at least one thermopile. For example, if the thermoelectric device 602 is substantially square-shaped, the interior aperture or recess of the thermoelectric module retaining plate 626 may also be substantially square-shaped. In an embodiment, the thermoelectric device 602 sits on top of the interior recess. Alternatively, the interior aperture may include at least one mounting platform 628 projecting into the open space. In this configuration, the thermoelectric device 602 may be placed on top of the at least one mounting platform 628. In another alternative embodiment, the thermoelectric module retaining plate may be a metal plate 630 without a recess or an aperture. In this configuration, thermal energy directed to the metal plate 630 will heat the metal plate 630, which is in contact with the thermoelectric device 602.

A thermal insulator layer 632 may be placed on top of the thermoelectric module retaining plate 626. The thermal insulator layer 632 defines an interior space that corresponds in shape with the thermoelectric device 602. The thermal insulator layer 632 may be made from a variety of materials capable of insulating heat, including, but not limited to, felt, wood, or a combination thereof. The top side 606 of the thermoelectric device 602 may be substantially flush with the top of the thermal insulator layer 632. In this manner, a heat sink 610 that is mounted on top of the thermal insulator layer 632 may be in contact with the top side 606 of the thermoelectric device 602.

The heat sink 610 may be mounted on top of the thermal insulator layer 632, which itself may be on top of the thermoelectric module retaining plate 626, which in turn may be on top of the main body 612. These elements may be affixed together through various means, including with screws 634, rivets, or nails, through corresponding and aligned holes in each component. Alternatively, as shown in FIG. 23, only the thermal insulator layer 632, thermoelectric module retaining plate 626, and the main body 612 are affixed together.

In an embodiment, the main body 612 may have a substantially cylindrical shape. In this configuration, the thermoelectric module retaining plate 626 and thermal insulator layer 632 may be similarly substantially circular or cylindrical.

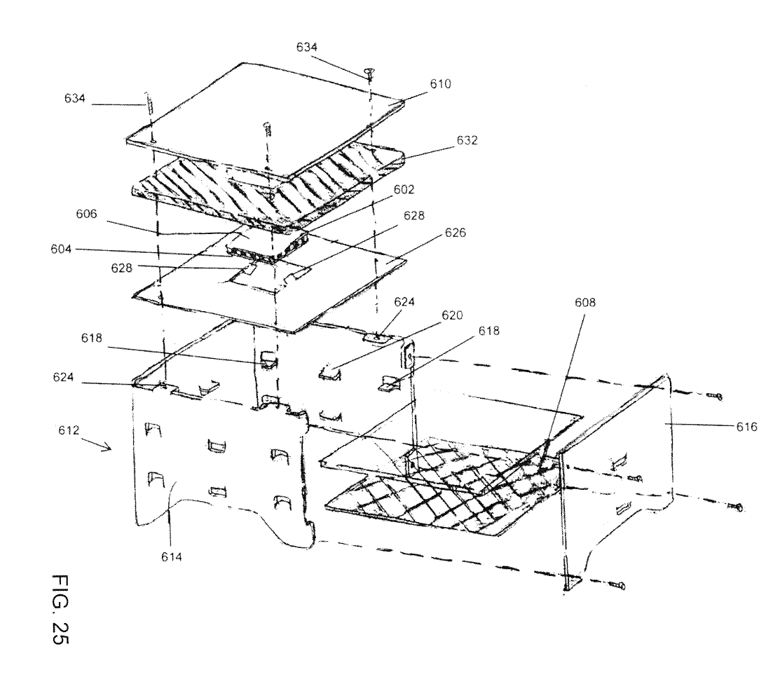

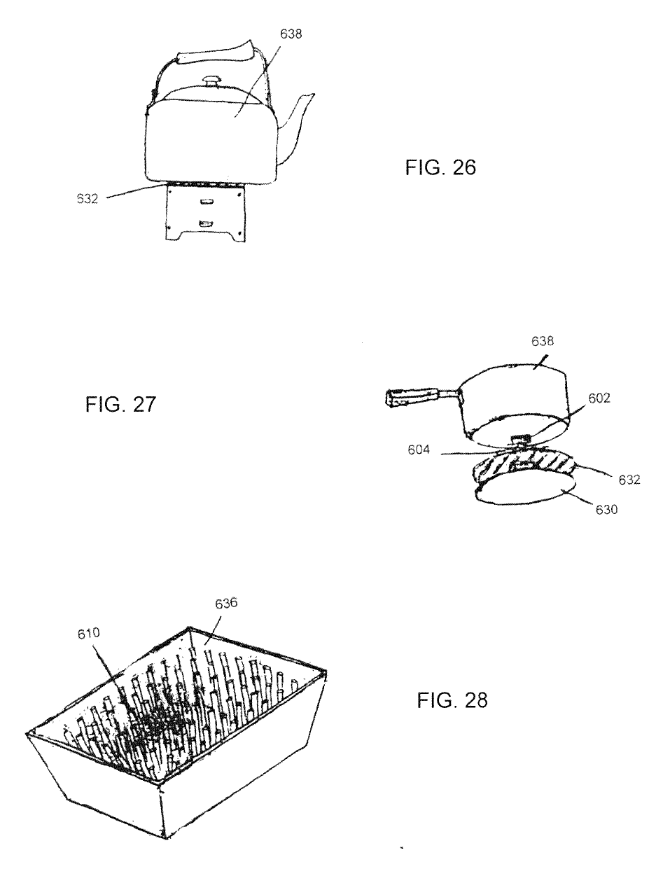

In another embodiment, to enhance the cold side 604 of the thermoelectric device 62, a small electric fan powered directly by the thermoelectric device 602 faces and cools the top side 606. Blowing air over or on top of the top side 606 draws heat away and/or cools the top side 606. Referring to FIGS. 26 and 27, in yet another embodiment, to enhance the cold side 606 of the thermoelectric device 602, a fluid resistor may be placed on the top side 606 of the thermoelectric device 602. A fluid resistor can dissipate energy, such as thermal energy. One example of a fluid resistor is a vessel 636 of water, such as a kettle 638 or a pot 639. The kettle 638 or pot 639 of water will draw thermal energy away from the top side 606 of the thermoelectric device 602, thereby accentuating the cold side. In this embodiment, because the thermoelectric device 602 is in thermal contact with a vessel 636, 638, 639 of water, the temperature of the cold side 606 never rises above 100 degrees Celsius—while the temperature of the hot side 604 may be much greater than 100 degrees Celsius. This embodiment increases the efficiency of electricity generation from the thermoelectric device 602, via the enhanced temperature gradient across the thermoelectric device 602, while still facilitating further uses, such as heating or boiling water, simultaneously.

In an alternative embodiment, the vessel 636 of water, such as a kettle 638 or pot 639, and thermoelectric device 602 may be used separately from the solar concentrator assembly 100, for example, on a stove or fire to generate electricity, in lieu of generating electricity via solar energy. For example, the vessel 636 of water may be placed on the top side 606 of the thermoelectric device 602 which is in turn placed on or above a stove or fire. Further, in a similar arrangement, the vessel 636 of water and thermoelectric device 602 may be placed in the receptacle 500, such that the vessel 636 of water and thermoelectric device 602 are disposed above the stove or fire when the receptacle 500 is placed about or above the stove or fire. In a further embodiment, the thermoelectric device 602 may be integrated into the bottom of the vessel 636 of water. For example, the thermoelectric device 602 may be integrally formed with or placed into a chamber or cavity in the bottom of the vessel 636 of water. In this arrangement, the top side 606 of the thermoelectric device 602 may be exposed to or in thermal contact with the bottom of the vessel 636 of water.

Referring back to FIG. 26, in an alternative embodiment, the thermoelectric module may use a combination of a fluid resistor 636, 638, 639 and a heat sink 610. For example, the heat sink 610 may be disposed in a watertight container 636, which may be filled during use. In this configuration, the bottom surface of the watertight container 636 may be in thermal contact with the thermoelectric device 602.

As an alternative to the thermoelectric module 600, a heat transfer module 700 may be used with the solar concentrator assembly 100. For example, when the solar concentrator assembly 100 is not being used for cooking or heating water, the heat transfer module 700 may be used to generate and/or circulate heat. The heat transfer module 700 may include a heating coil 702, a heat dissipater 704 connected to the heating coil 702, and a heat transfer fluid 706 that may circulate within and between the heating coil 702 and the heat dissipater 704. In this embodiment, the heating coil 702 may be placed in the receptacle 500. The heating coil 702 may be copper tubing that is tightly coiled. In this manner, the amount of tubing can be maximized in the focal region of the reflector dish. In an embodiment, the amount of tubing in the receptacle may be further maximized by utilizing tubing with a small diameter, e.g., with a 1 mm diameter. In an alternative embodiment, the heating coil 702 may be placed in a glass jar 708 for added insulation, which is placed in the receptacle 500.

The heat dissipater 704 may include an array of tubes 710 or a small tank 712. In an embodiment, the heat dissipater 704 may be placed at a slightly higher level than the heating coil 702. In this manner, heated heat transfer fluid 706 may more easily flow from the heating coil 702 to the heat dissipater 704, where the heat transfer fluid cools and sinks and the heat transfer fluid 706 flows back to the heating coil 702. The inlet 714 of the heating coil 702 is connected to the outlet 716 of the heat dissipater 704, and the outlet 718 of the heating coil 702 is connected to the inlet 720 of the heat dissipater 704. The heat dissipater 704 may be connected to the heating coil 702 through various durable insulating tubing. By way of example only, PEX tubing connects the heating coil to the heat dissipater.

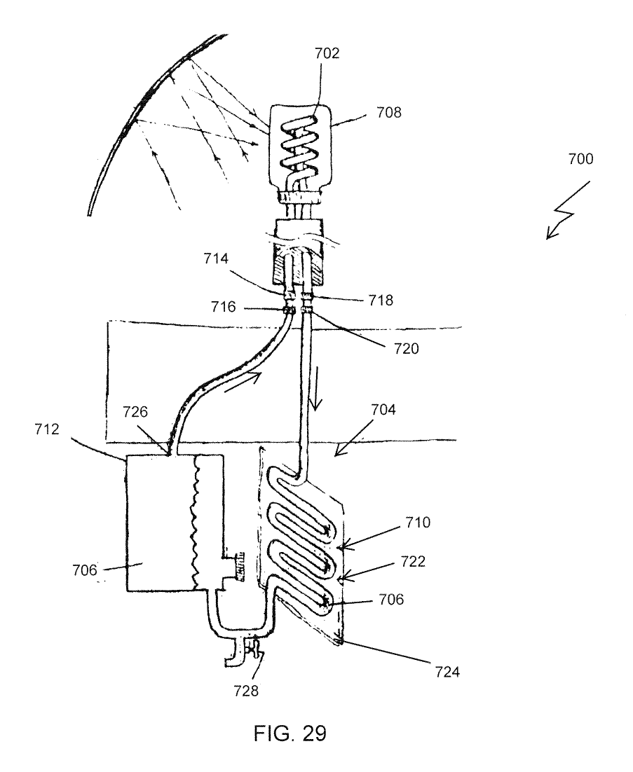

Alternatively, as shown in FIG. 29, the heat dissipater 704 includes both an array of tubes 710 and a small tank 712. Similar to a heat exchanger unit, a portion of the array of tubes 722 may be coiled and placed on a horizontal plane to increase the surface area of this portion as it exudes heat. For example, this portion of the array of tubes 722—a heat exchanging portion—may be placed in a central location of a residence or embedded in a sleeping platform to provide and exude heat from this increased surface area. Furthermore, this portion of the array of tubes 722 may be placed on top of insulated material 724 to keep the direction of heat transfer upward. In this embodiment, heat transfer fluid 706 flows from this heat exchanging portion 722 to a tank 712. The tank 712 may be a reservoir of cold heat transfer fluid 706. The outlet 726 from the tank may be placed somewhere about half of the height of the tank 712 such that the cold heat transfer fluid 706 may flow back to the heating coil 702 when the tank 712 starts to fill up. Alternatively, a spigot 728 may be placed between the heat exchanging unit portion 722 and the tank 712. In this configuration, if the heat transfer fluid 706 is water and it has reached sufficient temperature for pasteurization, the water may be collected at the spigot 728 for use.

The heat dissipater 704 may function as an indoor heater that may be used to radiate heat directly to an indoor living space. Alternatively, the heat dissipater 704 may be used to charge materials of appropriate heat capacity that may release heat for later use (e.g., at night time). Such materials may include paraffin, stone, or adobe. Additionally, a portion of the heat dissipater 704 may be embedded directly into or under the adobe or a sleeping platform, such that the adobe or sleeping platform may be heated during the day. The sleeping platform may be constructed from various materials, such as wood. In an additional or alternative embodiment, the sleeping platform is insulated by a mattress and/or blankets so that, over the course of a day, the sleeping platform retains much of the thermal energy from the heat dissipater 704. In this manner, a user will have a warmer bed to sleep in during a cold night. The heat dissipater 704 may also be used to heat clothing or bedding before use. In this embodiment, a portion of the heat dissipater 704, for example, tubing, may be positioned to run the heat transfer module 700 from the solar concentrator assembly 100, which is outdoors, to a residence. In this embodiment, the tubing may be contained within recycled plastic bottles with cardboard inserts laminated with aluminized plastic polymer film. The cardboard inserts are of the appropriate width to create a parabolic trough reflector that focuses solar radiation on the tubing to allow the heat transfer fluid to be heated outside of the solar concentrator assembly. These reflective heating components concentrate additional solar energy on the tubing while also insulating the tubing via the greenhouse effect. Within the residence, the tubing may be extended through the sleeping platform or the walls of the residence to reduce heat loss. To further minimize heat loss from the tubing, exposed lengths of the tubing may be wrapped in additional insulation (e.g., cloth, leather, fur, and grass or any other suitable insulated material). In addition or alternatively, the exposed lengths of tubing may be placed on top of insulated materials to reduce heat loss.

Because the heat transfer module 700 may be a closed circulation loop, the heat transfer fluid 706 may be non-toxic or toxic. For example, the heat transfer fluid 706 may be water or household oils, which may be desirable for their low-cost and availability. In an additional or alternative embodiment, antifreeze and alcohol may be used, in part to prevent water-based systems from freezing at night and to prevent water from becoming corrosive. Commercially available heat transfer fluids may also be used. In an embodiment, the heat transfer fluid 706 is a mixture of water and alcohol. For example, the mixture may be about one-half parts water and one-half parts alcohol. Alternatively, the alcohol component of this mixture may be greater or lesser than the water component.

Further as described hereinabove, heat transfer fluid 706 may flow through the heating coil 702 and the heat dissipater 704 passively or actively, due to the thermosiphon effect, various pumps, or a combination of both. Passive flow is due to the thermosiphon effect in which thermal energy heating the heat transfer fluid 706 induces movement and circulation of the heat transfer fluid 706 through the heat transfer module 700. For example, in the embodiment where at least a portion of the heat dissipater 704 is elevated slightly higher than the heating coil 702, heat transfer fluid 706 may flow through the heat transfer module 700 due to the thermosiphon effect and the pressure or height difference. Alternatively, the heat transfer fluid 706 may move through the module by active means using various pump arrangements. For example, in conditions in which the passive thermosiphon effect cannot overcome heat loss from the dissipater, a small pump may be used to facilitate flow of the heat transfer fluid 706. An electric pump, which may be powered or charged by the thermoelectric device 602, may be used. In further embodiments, various mechanical pumps may be used, including, but not limited to, bucket gravity pumps and hand pumps. For example, hand pumps may be rotary hand pumps built into existing household items, such as prayer wheels.

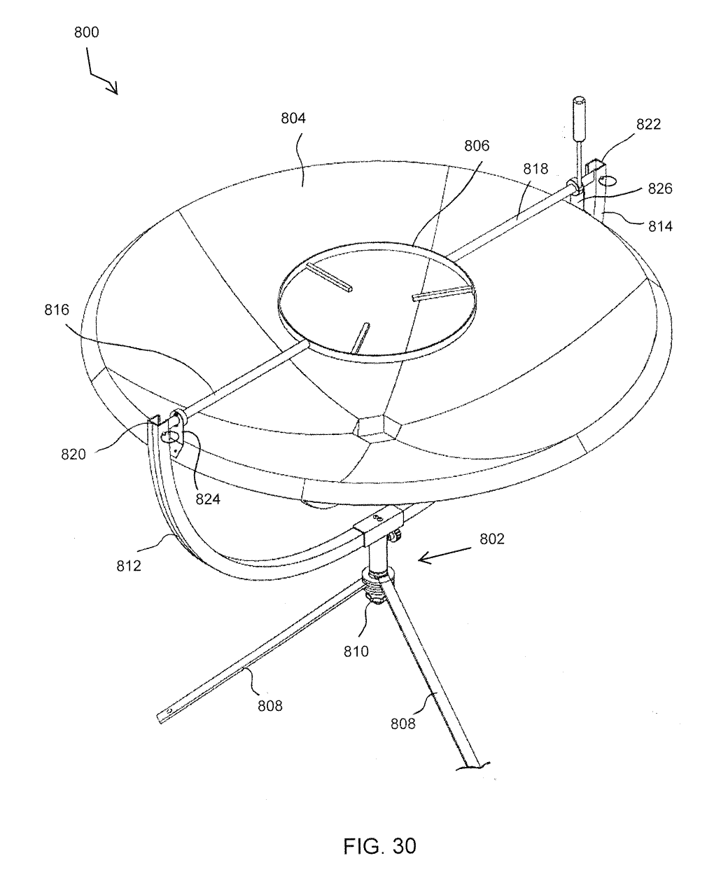

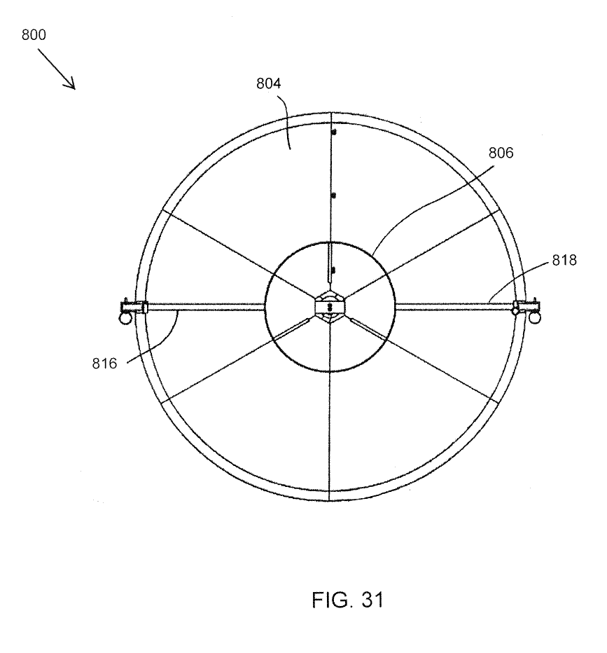

Referring to FIGS. 30 and 31, an embodiment of a solar concentrator assembly 800 includes a stand 802, a rigid dish 804, and a pot stand 806. The stand 802 includes a plurality of legs 808 joined together at a vertical support assembly 810. The stand 802 also includes curved support members 812, 814 that are connected to the vertical support assembly 810 and curve under and around the rigid dish 804. The pot stand 806 is supported with hanging shafts 816, 818 that are attached at top or distal ends 820, 822 of the curved support members 812, 814. The rigid dish 804 is suspended from the hanging shafts 816, 818 by hangers 824, 826.

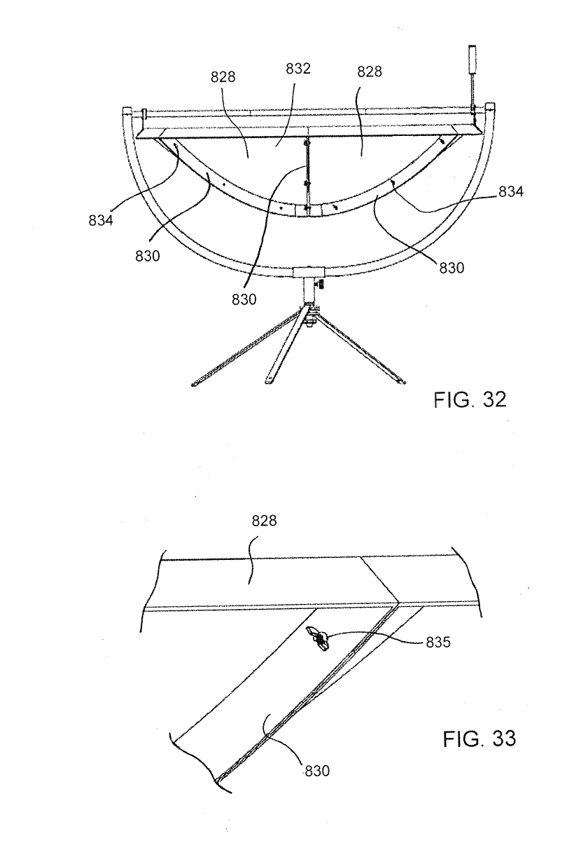

In an embodiment depicted in FIGS. 32 and 33, the rigid dish 804 includes a plurality of rigid panels 828. Side walls 830 extend from a bottom surface 832 at a perimeter of each rigid panel 828. The side walls 830 provide rigid support for panels 828 and allow the panels 828 to be joined together to form the rigid dish 804. For example, as depicted, the side walls 830 of adjacent rigid panels 828 may include wall holes 834 to allow the rigid panels 828 to be secured together using a wingnut 835. Additional fasteners, such as screws, nuts, clips, clamps, snaps, ties, and/or adhesives may be used. For example, plastic snaps may be integrated into the rigid panels 828, and/or temporary or permanent ties may be used.

Rigid panels 828 may be made of any suitable materials that are sufficiently rigid, lightweight, corrosion resistant, and reflective. For example, the rigid panels 828 may be vacuum formed or injection molded plastic panels or stamped or die formed sheet metal. A top surface 836 of the panels 828 includes a reflective layer or coating. For example the top surface 836 may be (i) metalized using vacuum deposition, (ii) electroplated using a transparent conductive layer, and/or (iii) laminated or molded to a metalized MYLAR® (PET) film or metal (e.g. aluminum) foil. In addition, the panels 828 may be coated with a layer of acrylic or other protective polymer to, for example, provide corrosion resistance, scratch resistance, and/or UV resistance.

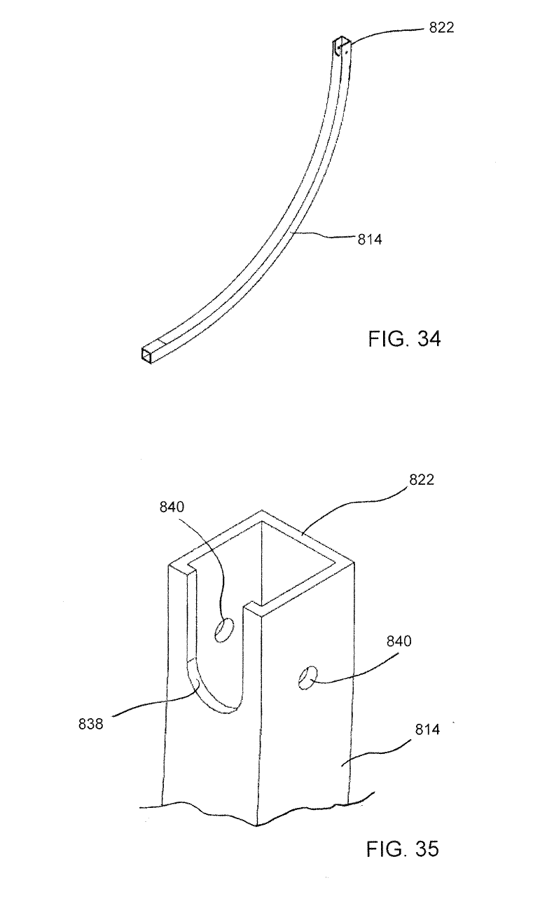

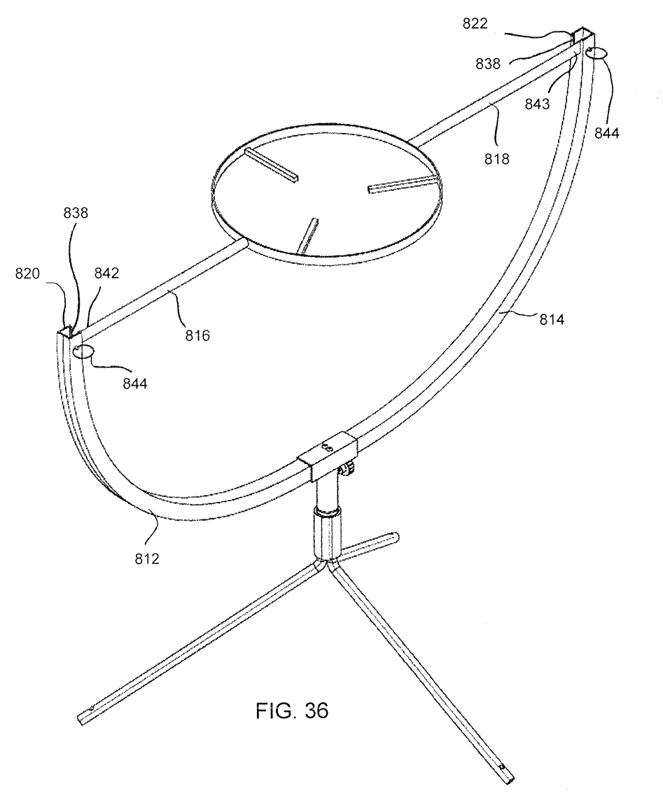

Referring to FIGS. 34, 35, and 36, the distal ends 820, 822 of curved support members 812, 814 may include a notch 838 and through-hole 840 to support and attach the hanging shafts 816, 818. As depicted in FIG. 36, outer ends 842, 843 of the hanging shafts 816, 818 pass through and are supported by the notch 838 in each curved support member 812, 814. The outer ends 842, 843 include a hole or opening to allow the hanging shafts 816, 818 to be secured to the curved support members 812, 814 using, for example, linchpins 844. The linchpins 844 or other mechanical fastener prevent the hanging shafts 816, 818 from rotating about their central axes.

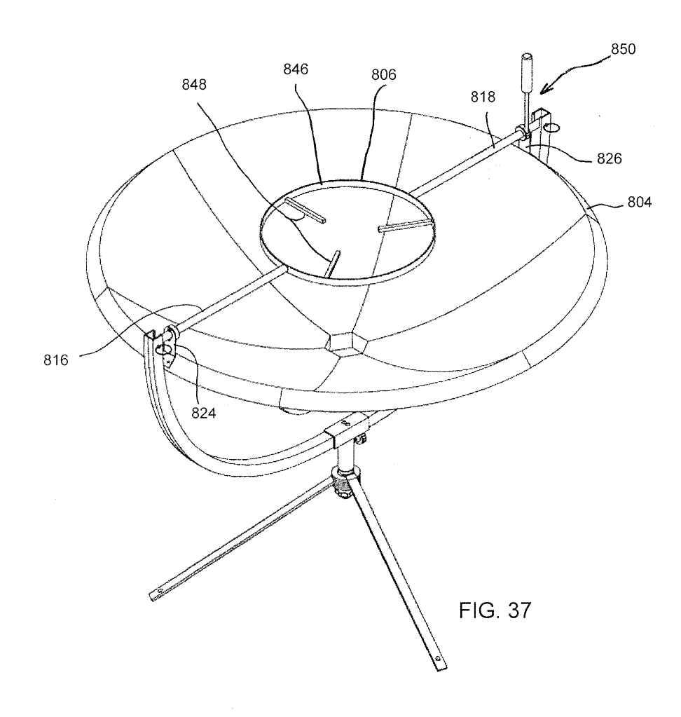

Referring to FIG. 37, in one embodiment, the pot stand 806 includes a rim 846 and spokes 848. As depicted, the rim 846 may be circular and the spokes 848 may extend toward a center of the rim 846 in a radial direction. In other embodiments, the rim 846 may be any shape, such as square, rectangular, triangular, or oval. In addition, while the spokes 848 are depicted as being shorter than a radius of the rim 846, the spokes 848 may also have a length equal to or greater than the radius of the rim 846. As discussed above, the pot stand 806 may be used to support a container of water, such as a kettle, pot, or pan. The pot stand 806 may also be used to support the thermoelectric module 600 and/or the heat transfer module 700, described above.

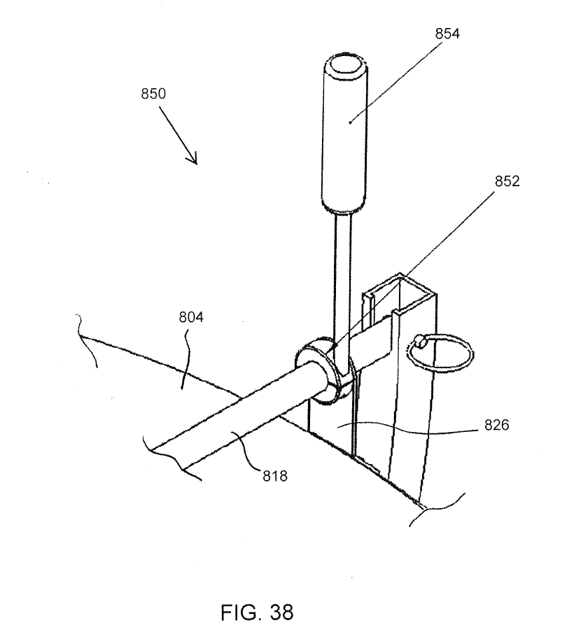

FIGS. 37 and 38 depict an embodiment of a hanging assembly 850 for the rigid dish 804. The hanging assembly 850 includes the hanging shafts 816, 818, the hangers 824, 826, a locking collar 852, and a clamp handle 854. As depicted, the hanging shaft 818 passes through the center of the locking collar 852. The hanger 826 is attached to the locking collar 852, and the rigid dish 804 is suspended from the locking collar 852 using the hangers 824, 826.

The angular position of the locking collar 852 may be adjusted using the clamp handle 854. For example, the locking collar 852 may be a split collar and the clamp handle 854 may include a threaded end. By rotating the clamp handle 854 about its central axis, the two halves of the split collar may be moved apart to loosen the locking collar 852 so that it is free to rotate around the hanging shaft 818. With the locking collar 852 loose, the locking collar 852, the hangers 824, 826, and the rigid dish 804 may be rotated about the center axis of the hanging shafts 816, 818 by pushing or pulling on the clamp handle 854. This allows the rigid dish 804 to be tilted at a desired angle with respect to the horizon (i.e., altitude). Once the rigid dish 804 is at the desired angle, the locking collar 852 may be tightened on the hanging shaft 818 by again rotating the clamp handle 854 about its central axis. With the locking collar 852 secured to the hanging shaft 818, the angle or altitude of the rigid dish 804 may be fixed. In other embodiments, the altitude of the rigid dish 804 is fixed using a set screw that passes, for example, through a collar and into contact with the hanging shaft 818.

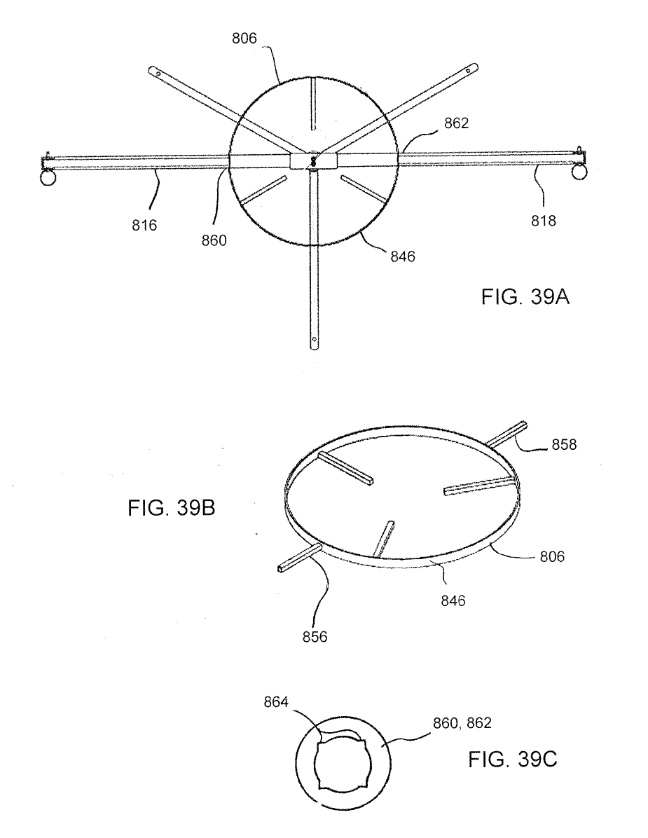

Referring to FIGS. 39a, 39b, and 39c, to attach the pot stand 806 to the hanging shafts 816, 818, the pot stand 806 may include stubs 856, 858 that extend from the rim 846 into hollow ends 860, 862 of the hanging shafts 816, 818. To prevent rotation of the pot stand 806 with respect to the hanging shafts 816, 818, a cross-section of the stubs 856, 858 may not be round. For example, the cross-section of the stubs 856, 858 may be rectangular, triangular, star-shaped, or, as depicted in FIG. 39b, square. To provide the desired fit, an interior surface of the hollow ends 860, 862 is adapted to receive the stubs 856, 858 and prevent rotation of the stubs 856, 858, with respect to the hanging shafts 816, 818, once received therein. For example, as depicted in FIG. 39c, an interior surface of the hollow ends 860, 862 may include stub notches 864 to accommodate corners of the square stubs 856, 858.

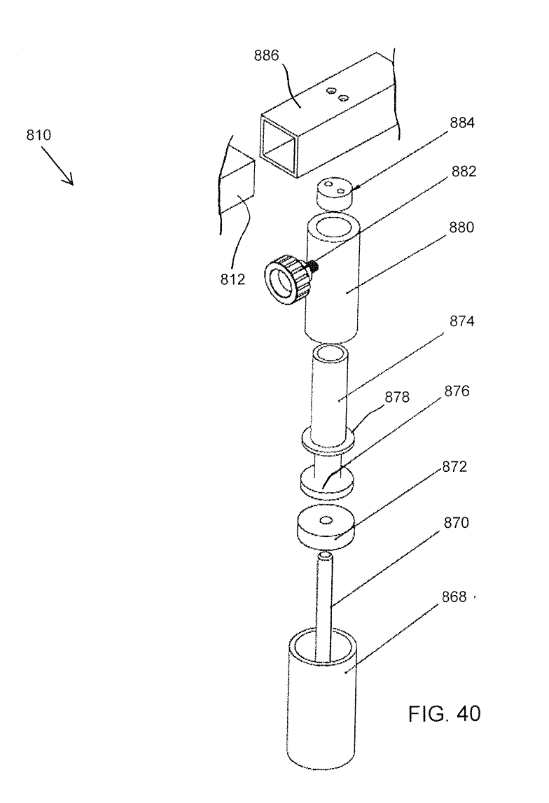

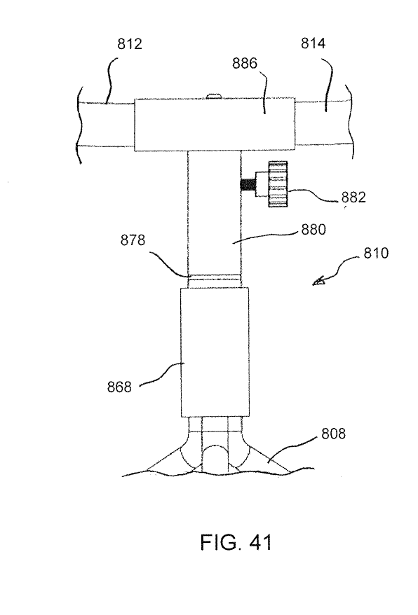

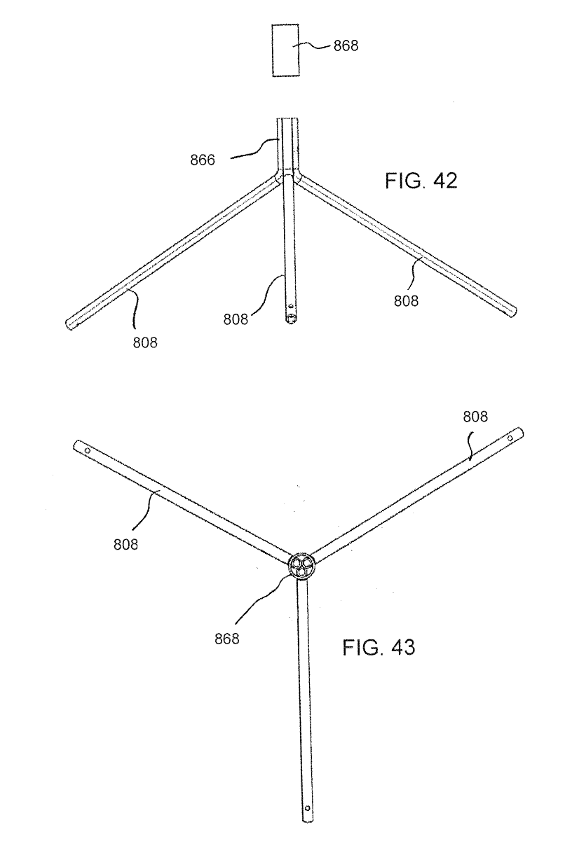

Referring to FIGS. 40-43, an embodiment of the vertical support assembly 810 of the stand 802 attaches the legs 808 to the curved support members 812, 814. Top ends 866 of the legs 808 are housed within a leg tube 868. A threaded rod 870 extends upward from the center of the leg tube 868, through a lower disc 872 and into a hollow sleeve 874. The lower disc 872 may be attached to the leg tube 868 using, for example, a press-fit, adhesive, and/or welding. A base of the hollow sleeve 874 includes a support disc 876. The hollow sleeve 874 also includes a flange 878 positioned above the support disc 876. A top portion of the hollow sleeve 874 passes into a bushing 880. The bushing 880 includes a threaded hole to accommodate a threaded locking knob 882. An upper disc 884 is inserted into a top portion of the bushing 880. The upper disc 884 may be attached to the bushing 880 using, for example, a press-fit, adhesive, and/or welding. A hollow bar segment 886 is adapted to receive a lower end of the curved support members 812, 814 and is attached to the upper disc 884 using, for example, screws.

The components of the stand 802 may be made of any sufficiently rigid and corrosion resistant materials. For example, the leg tube 868, the lower disc 872, the bushing 880, and the upper disc 884 may be made of one or more metals, such as aluminum. The hollow sleeve 874, support disc 876, and flange 878 may be made of plastic. The hollow bar segment 886 and/or curved support members 812, 814 may be made of rigid plastic and/or aluminum.

To adjust the heading (e.g., north, south, east, or west) of the rigid dish 804, the rigid dish 804 may be rotated about a central support axis 888 (e.g., a vertical axis) of the vertical support assembly 810, with respect to the legs 808. Specifically, by loosening the threaded locking knob 882, the curved support members 812, 814 and rigid dish 804 are free to rotate about the central support axis 888. Once the desired heading has been obtained, further rotation of the rigid dish 804 about the central support axis 888 may be prevented by rotating the threaded locking knob 882 until it engages the hollow sleeve 874.

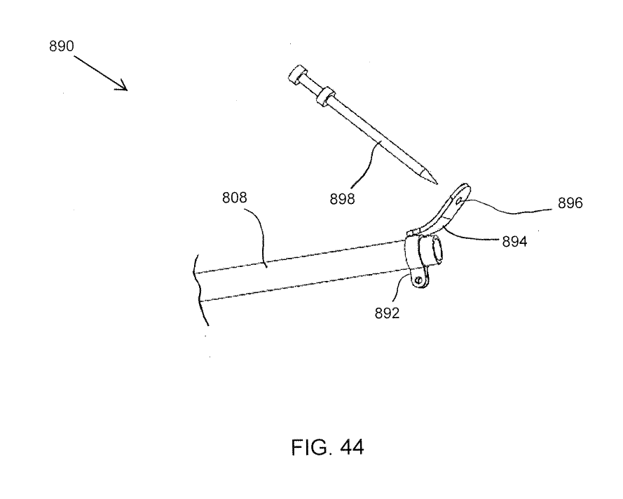

Referring to FIG. 44, a staking assembly 890 is provided to anchor the legs 808 to the ground. In one embodiment, the staking assembly 890 includes a leg collar 892 attached to a bottom of a leg 808. A flexible strap 894 is attached to the leg collar 892 and includes a strap hole 896 at a distal end. A stake 898 may be passed through the strap hole 896 and driven into the ground. The leg collar 892 and stake 898 may be made of a rigid plastic and/or one or more metals, such as aluminum or stainless steel. The flexible strap 894 may be made of plastic and/or leather.

The stand 802 is lightweight, easy to assemble, and its components may be made of one or more metals, plastic, wood, and/or bamboo. As described above, the hanging assembly 850 and vertical support assembly 810 allow the altitude and heading of the rigid dish 804 to be adjusted and locked in place using an innovative tension-lock system. In certain embodiments, the stand 802 is used with the rigid dish 804 and/or the reflective dish module 400, including the pliable material 404.

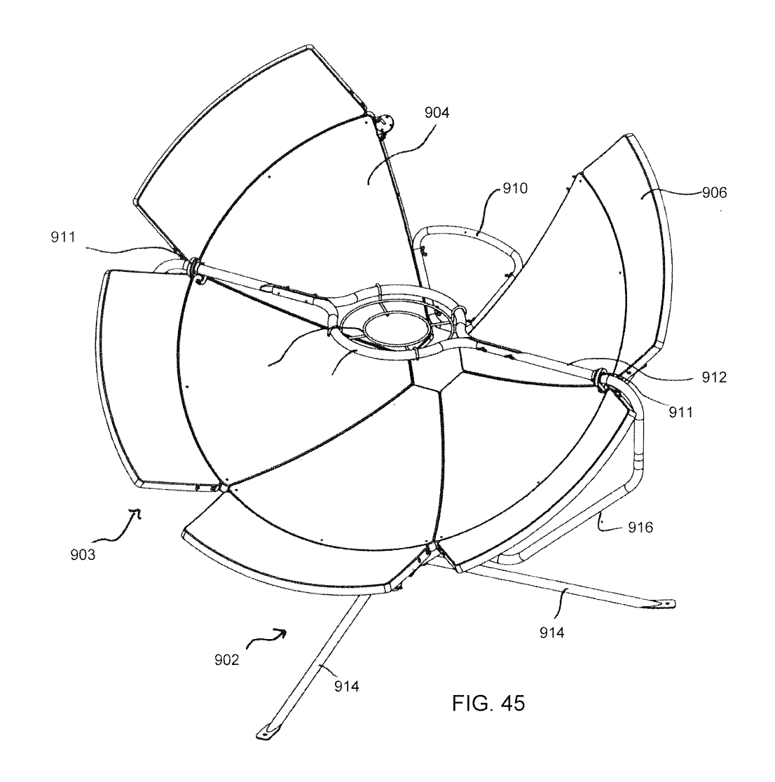

FIGS. 45 through 48 depict various views of an embodiment of a solar concentrator assembly 900. The solar concentrator assembly 900 has various modules, including a base module 902, a reflective dish module 903 having inner panels 904 and outer panels 906, and a crossbar module 912. These modules may be manufactured and designed to be lightweight, portable, and easily assembled and disassembled. For example, various components of the modules may be made from lightweight, yet sturdy materials, such as sheet metal (e.g., aluminum), bamboo, plastics, textiles, and/or canvas. Moreover, the base module 902, crossbar module 912, and the reflective dish module 903 may be collapsible, foldable, and/or composed of multiple detachable components.

In some embodiments, the solar concentrator 900 may include additional components useful to an operator, such as a mechanism for assisting the operator in focusing the concentrator 900 in the direction of the sun. The mechanism may operate similarly to a sundial; for example, a cylindrical rod or other suitable shape may be affixed to the concentrator 900, such that the sun casts a shadow onto guide markings on the concentrator 900. The guide markings inform the operator how the reflective dish 903 should be adjusted to receive an optimal amount of solar energy. The concentrator 900 may also include appropriate markings for indicating the time of day.

The base module 902 may share characteristics similar to the base and tripod modules described above with respect to FIGS. 5, 6, 12, and 13. For example, in the depicted embodiment, the base 902 includes a plurality of legs 914 that may be formed so as to grip the ground or allow for other means of securing the base to the ground, such as with stakes. The base module 902 enables the concentrator to rotate around multiple axes to adjust the azimuth and the elevation angle of the reflective dish 903 in order to optimize the amount of radiation collected. The base 902 is configured so as to elevate the concentrator 900 above the ground enough such that the reflector can achieve a sufficiently minimal vertical angle to make use of radiation availability in the early morning and late evening, when the sun is low on the horizon. The base 902 further elevates a target and/or focal point of the reflective dish 903 above the ground to place it at an ergonomic height for operators to interact with a receiver placed in the focal point (such as a cooking pot). The base module 902 can rest on any surface ranging from a zero degree angle to a 25 degree angle, with respect to the horizontal.

The crossbar module 912 is attached to the base module 902 by connectors, piping, and/or other supporting structure which may be secured by tension-fitting, thumbscrews, wingnuts, pegs, or other appropriate means of fastening. The piping may consist of various lengths of straight and/or angled pipes 916 connecting the crossbar 912 with base piping 918. The base piping 918 is secured to the base module 902 such that rotation along a longitudinal axis of the base piping 918 does not occur.

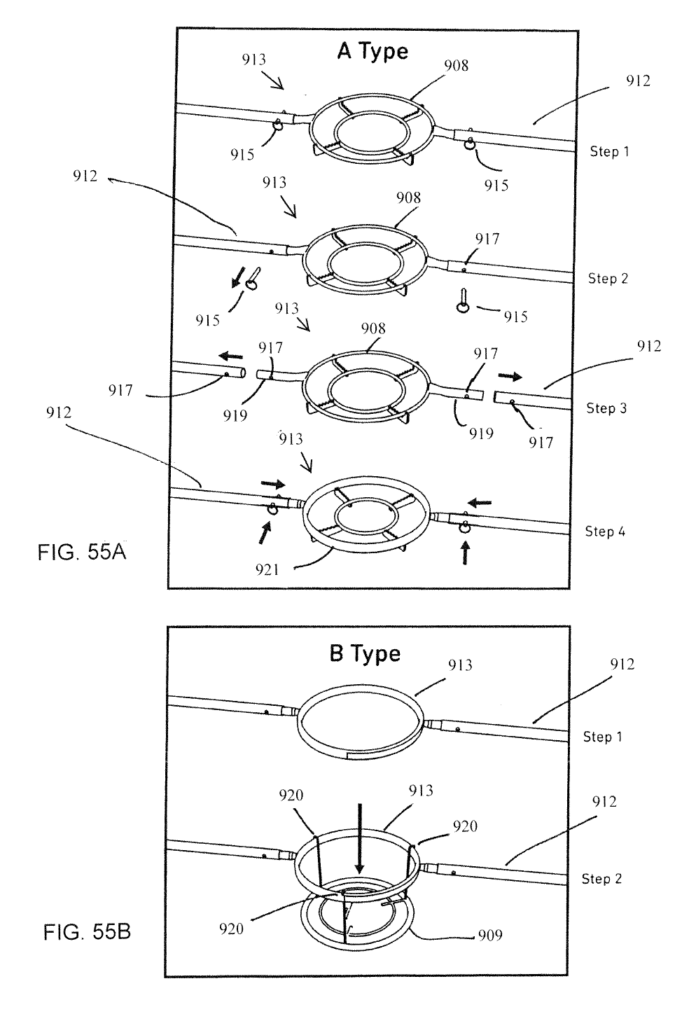

The crossbar module 912 includes a center portion 913 configured to hold an object at a target or focal point of the concentrator 900. The center portion 913 includes a holder or stand 908 usable for supporting a kettle, pot, plate, or some other object to be heated. As depicted in FIGS. 55a and 55b, the stand 908 may have a modular configuration, allowing a user to easily remove and replace the stand 908. Different forms of the stand 908 may be interchangeable such that different types of cookware and/or styles of cooking may be accommodated. Examples of forms that the stand 908 may take include an open ring, concentric rings, a coil, a spiral, a grid, a flat plate, an insulating flat plate, or any other form suitable for heating a target object. The stand may be constructed of opaque, translucent, and/or transparent material.

The stand 908 may be connected to the crossbar 912 via a locking mechanism, as shown in FIG. 55a. The locking mechanism may include removable or spring-loaded pins, tension devices, screws, bolts, wing nuts, or other suitable means for fixedly coupling the stand 908 and cross bar 912. As shown in Step 1, two pieces of tubing 919 are attached to opposite sides of the circular stand 908. The pieces of tubing 919 are coaxially aligned with the crossbar 912 and have a slightly smaller diameter so as to fit inside a hollow portion of the crossbar 912. To remove the stand 908 from the crossbar 912, two pins 915 on either side of the crossbar 912 are pulled out from holes 917 extending through the crossbar 912 and through the tubing 919 attached to the stand 908 (Step 2). In Step 3, one or both of the separated ends of the crossbar 912 are pulled in opposite directions so that the stand 908 can be removed and a different stand 921 can be inserted. The pins 915 are then replaced to lock the new stand 921 in position.

In another example, illustrated in FIG. 55b, the stand 908 is configured in the form of an insert 909 that hangs from or otherwise interfaces with the crossbar 912. As shown, the stand 908 may include a center portion 913 configured to receive a hanging insert 909 (Step 1). The stand 908 may be coupled to the crossbar 912 as described with respect to FIG. 55a. In Step 2, the insert 909 is attached to the center portion 913 by inserting the insert 909 at the top of the center portion 913 and allowing hooks 920 on the insert 909 to grasp the perimeter of the center portion 913. The stand 908 may include any suitable means for attaching an insert, including hooks, magnets, latches, tabs, flanges, or other manner of interfacing an insert to a receptacle or other supporting structure on the crossbar 912.

In some embodiments, the center portion 913 is interchangeable such that other configurations may be used. For example, the center portion 913, holder 908, or both may be replaced with an electrical generation or distillation device, components suited to support the thermoelectric module 600 and/or the heat transfer module 700 described above, or other similar device.

The crossbar module 912 further supports the reflective dish module 903. Referring to FIGS. 45 through 48, in one embodiment the reflective dish 903 is suspended from the crossbar 912 by means of circular connectors 911 disposed towards axial ends of the crossbar 912 and attached to the inner panels 904 of the dish 903. The circular connectors 911 may include a tensioning, ratcheting or other type of locking mechanism to ensure that an operator of the solar concentrator 900 can fix the position of the reflector dish 903 without unintended movement or rotation of the dish 903 along or around the longitudinal axis of the crossbar 912. In other embodiments, the reflective dish 903 is coupled to the connector piping 916, the base module 902, or other component of the solar concentrator 900. Any suitable connector allowing for tilting of the dish module 903 may be used.

The reflective dish module 903 includes one or more inner panels 904 and one or more outer panels 906 attached to the inner panels 904. The inner panels 904 are adapted to reflect solar energy toward the focal point of the reflector dish 903, where the center portion 913 of the crossbar 912 holds an object to be heated. As described above with respect to FIGS. 1 through 4, the inner panels 904 and/or outer panels 906 may be constructed of pliable material, such as fabric or plastic, with a reflective material disposed thereon. Alternatively, as described above with respect to FIGS. 32 and 33, the reflective dish module 903 may include rigid panels made of plastic, sheet metal, or other suitably rigid material, and coated or covered with a reflective material. Use of plastic for the panels allows the solar concentrator 900 to incorporate connection features that are not possible with other materials, while also being low-cost. Further, plastic panels have the benefit of generally being weather- and impact-resistant. The inner panels 904 may be fixed together by any suitable means, such as thumbscrews, wingnuts, clips, clamps, ties, hook-and-loop fasteners (e.g., VELCRO), snaps, and/or adhesives.

In certain embodiments, the shape of the assembled reflective dish 903 takes the form of any parabola-type shape. For example, the shape may include a uniform parabola or a compound parabola, in which certain sections or portions of the assembled reflector dish are substantially parabloid and other remaining sections or portions may take the form of any geometric shape. In some embodiments, the reflective dish 903 may be asymmetric, where not all the inner panels 904 and/or outer panels 906 are of equal size to each other and certain panels are shaped differently to take advantage of solar incident angle.

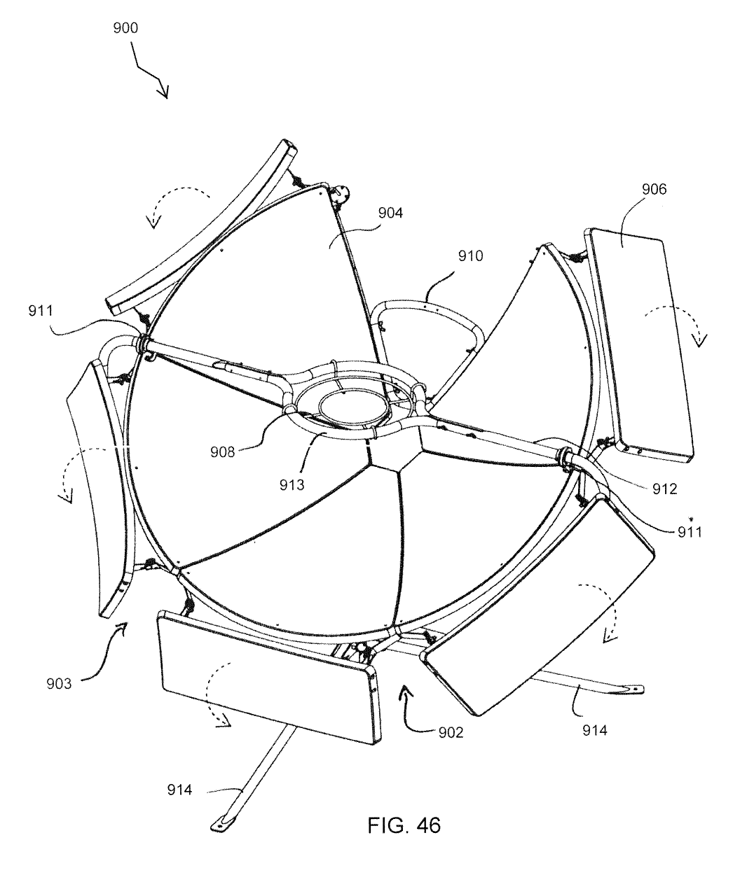

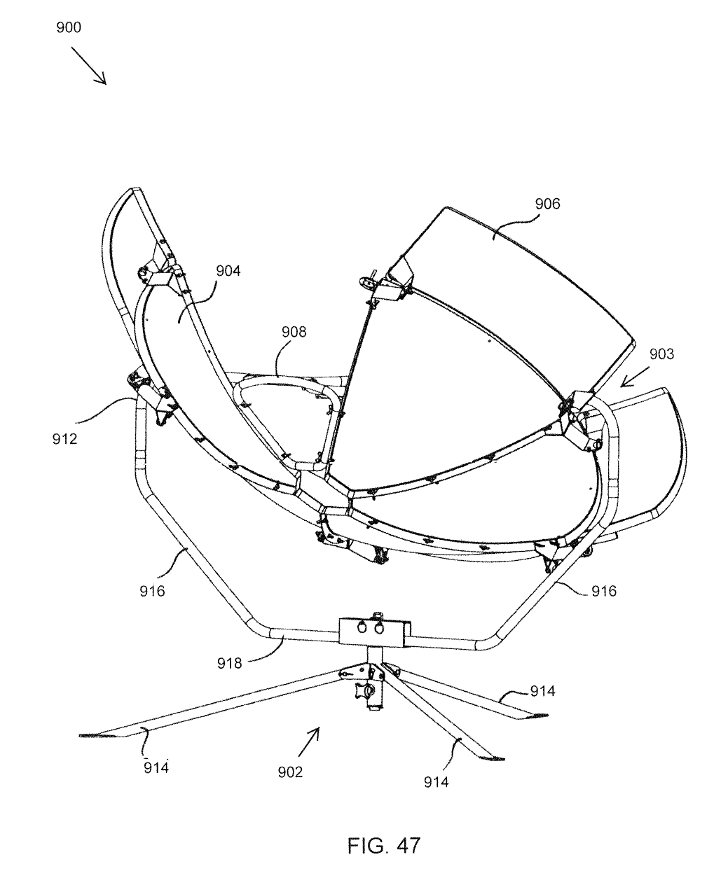

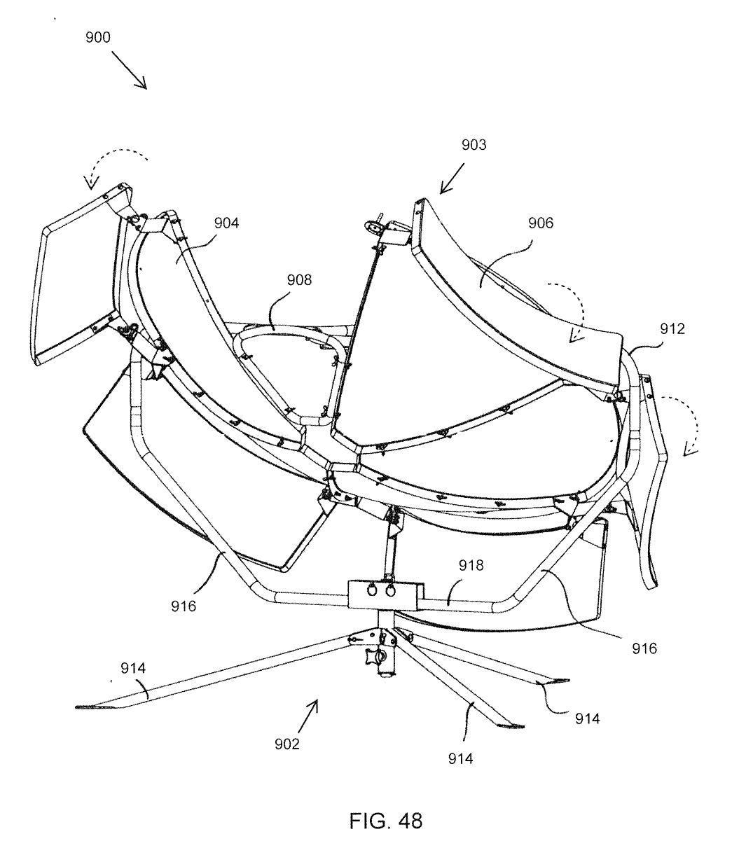

In various embodiments, the outer panels 906 are adjustable in relation to the inner panels 904, and allow additional solar energy to be directed toward the focal point of the reflective dish 903. As shown in FIGS. 45 and 47, the outer panels 906 are fixable in an active position such that the outer panels 906 form a continuous surface with the inner panels 904. In the active position, the outer panels 904 are in an optimal position to reflect solar energy toward the focal point of the reflective dish 903. In using the solar concentrator 900, an operator can adjust an amount of solar energy applied to an object by selecting one or more of the outer panels 906 to place in the active position. Referring to FIGS. 46 and 48, the outer panels 904 may also be moved to an inactive position, causing solar energy to be reflected away from the focal point of the reflective dish 903. In the inactive position, the outer panels may be locked in place or may hang freely.

The outer panels 906 may be attached to the inner panels 904 by any suitable adjustable connector, such as hinges, flexible straps, pins, bolts, magnets, hook-and-loop fasteners, snaps, buckles, and/or threaded loops. The connector may include a locking or tension mechanism such that the outer panels 906 may be fixed in one or more positions between the active position and the inactive position. By adjusting the outer panels to these different positions, an operator may vary the amount of solar energy directed at the focal point of the reflective dish 903 more precisely. In some embodiments, the solar concentrator 900 may be operated without the outer panels 906, and, in some instances, the outer panels 906 may be easily detachable by an operator of the concentrator 900.

In some embodiments, one or more of the inner panels 904 (and attached outer panels 906, if any) may be removed and replaced with a user hold-bar 910. For example, if manual operation of the solar concentrator 900 is desired, material can be removed from the concentrator 900 perimeter to allow ergonomic manual operation without compromising structural integrity. This enables an operator to more ergonomically place and interact with receivers (such as cooking pots) inside the concentrator 900. It also enable the operator to more ergonomically adjust the concentrator 900 and protects the operator's eyes from glare from the concentrator 900, which may include harmful UV radiation. The hold-bar 910 may be affixed to the inner panels 904 or other hold-bars in the same manner as the inner panels 904 are attached to each other, as described above.

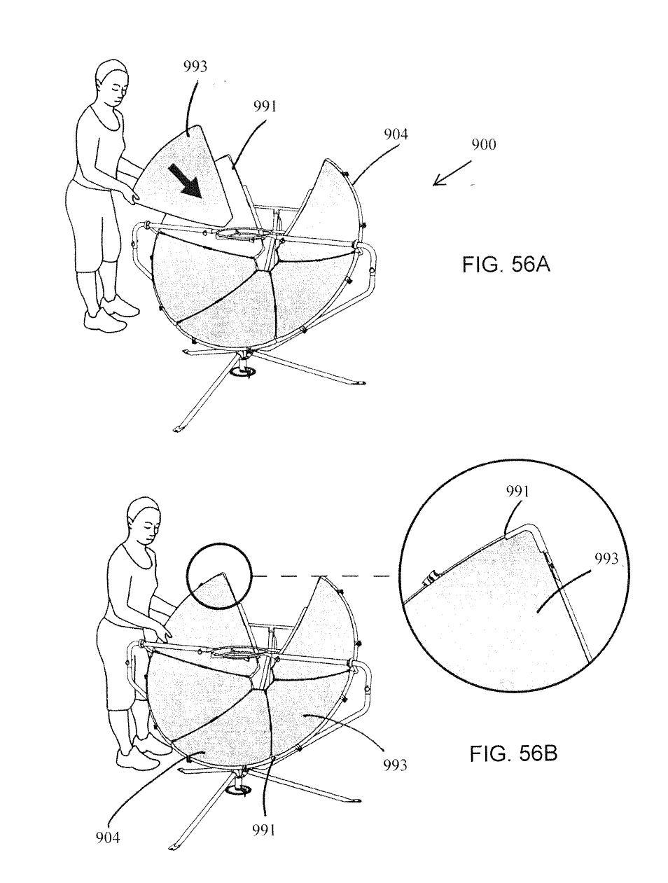

Referring to FIGS. 56a and 56b, in one implementation, one or more of the inner panels 904 and/or outer panels 906, if any, include a rigid frame 991 and a removable reflective panel component 993. The rigid frame may remain affixed to the solar concentrator 900, while the reflective panel component 993 is separately removable for disassembly, storage, replacement, cleaning, and/or maintenance. The rigid frame 991 may have a solid backing, as depicted, or may have a partial backing for support. If the reflective panel component 993 is constructed to be sufficiently rigid, the frame 991 may support the component 993 at the perimeter but otherwise have no backing portion to support a center portion of the component 993. The reflective panel component 993 may be attached and/or removed from the frame 991 by any suitable mechanism; for example, the panel component 993 may snap into the frame 991 along the edges of the panel component 993 or may slide into and out of grooves in the frame 991. In other embodiments, the reflective panel component 993 is coupled to the frame 991 by clips, snaps, tension, hook-and-loop fasteners, or other suitable fasteners.

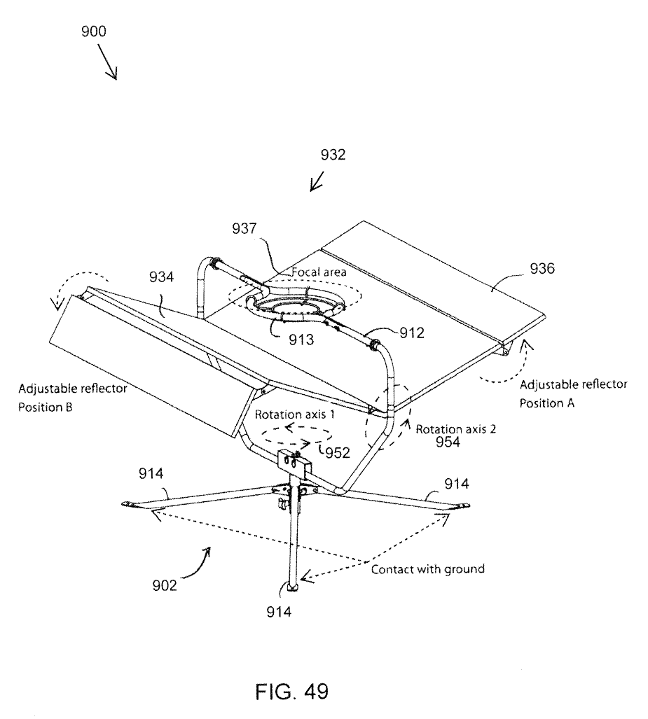

Referring to FIG. 49, in one embodiment of the invention, the solar concentrator 900 includes a simplified reflector assembly 932 in place of the reflective dish 903 shown in FIGS. 45 through 48. The simplified reflector 932 operates similarly to the reflective dish 903, but differs primarily in shape. The simplified reflector 932 includes one or more inner panels 934 and one or more outer panels 936 attached to the inner panels 934. The outer panels 936 may be placed in active positions, such that additional solar energy is reflected toward the focal area 937. Alternatively, the outer panels 936 may be placed in inactive positions so that solar energy is reflected away from the focal area 937. An operator may adjust the azimuth of the solar concentrator 900 by rotating it around rotation axis 952, and may adjust the elevation angle of the concentrator 900 by rotating it around rotation axis 954. In this manner, the operator can position the reflector to receive the desired amount of solar energy.

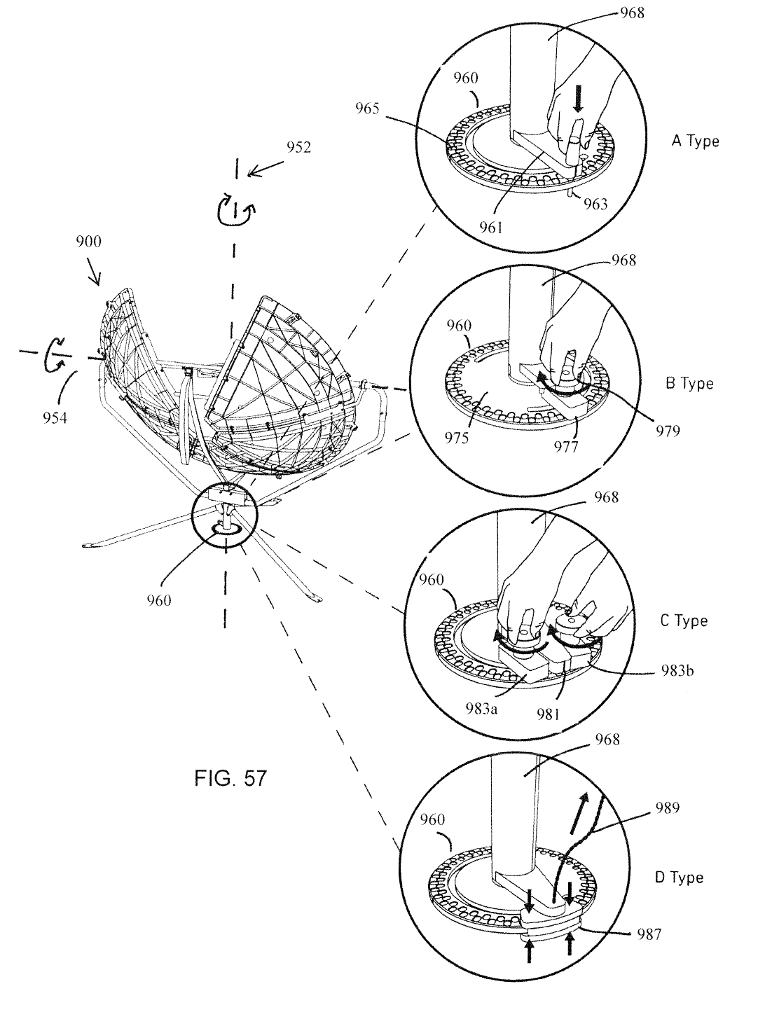

The solar concentrator 900 may include one or more braking mechanisms to slow or stop rotational movement of the solar concentrator around, for example, rotation axis 952 and/or rotation axis 954. In various embodiments, as illustrated in FIG. 57, the solar concentrator 900 includes a brake disc 960 to lock the position of the solar concentrator 900 and prevent rotational movement around vertical rotation axis 952 (thereby allowing a user to fixedly point the solar concentrator 900 in a desired compass direction). The brake disc 960 and a locking mechanism that interfaces with the brake disc 960 are affixed to components of the solar concentrator 900 that are able to rotate independently of each other. Thus, when the locking mechanism engages with the brake disc 960, rotation of the components with respect to each other is inhibited or prevented. The brake disc 960 may have a large radius (e.g., 6 to 12 inches) to provide a mechanical braking advantage (i.e., improved torque) as well as a greater number adjustment positions (for a locking brake) and a larger surface area for applying the brake (for a tension or friction brake). The braking mechanisms may be particularly advantageous in windy conditions.

The brake disc 960 may be configured to prevent the solar concentrator 900 from rotating using an adjustable mechanical interface. For example, as shown for the A Type configuration, the solar concentrator 900 includes a rigid arm 961 affixed to vertical base piping 968. The rigid arm 961 includes a sliding pin 963 which may be inserted through the arm 961 and into one of a set of fixed holes 965 that are arranged in a circular pattern on a surface of the brake disc 960, effectively preventing rotation of the solar concentrator 900. The pin 963 may be removed from one or both of the brake disc 960 and the rigid arm 961 to allow the solar concentrator 900 to rotate freely around rotational axis 952.

Other mechanical interfaces with the brake disc 960 are contemplated. For example, for B Type, the brake disc 960 may have a friction-inducing top surface 975, such as a rubber pad. To lock the solar concentrator 900 in place, or otherwise increase the amount of force required to rotate the concentrator 900, a brake pad 977 may be adjustably coupled to the vertical base piping 968. In the depicted embodiment, the brake pad 977 is positioned using adjustable screw 979. Tightening the adjustable screw 979 causes the brake pad 977 to advance toward the friction-inducing surface 975 of the brake disc 960, ultimately making contact with the surface 975. The material or structure of the surface 975 and/or the brake pad 977 is such that, when in contact, a frictional force restricts independent movement between the two components when a rotational force is applied to the solar concentrator 900. In some embodiments, the brake disc 960 does not include a friction-inducing pad; however, the brake pad 977 is configured to provide sufficient friction to restrict rotational movement of the pad 977 with respect to the brake disc 960. Further, other mechanisms may be used to adjust the brake pad 977, such as a bolt, lever, or handle.

Still referring to FIG. 57, C Type depicts another exemplary variant on the braking mechanism. A rigid arm 981 is affixed to vertical base piping 968. To prevent rotation of the arm 981 around the central axis of the solar concentrator 900, two friction pads 983a and 983b may be disposed on either side of the rigid arm 981 and adjusted to provide a downward force on the brake disc 960 in a similar fashion to the brake pad 977 of B Type. The friction pads 983a and 983b may be placed in direct contact with either side of the rigid arm 960, or may be positioned so as provide a spacing between the arm 960 and one or more of the pads 983a and 983b, thereby creating a fixed range of rotation for the solar concentrator 900. The friction pads 983a and 983b may be coupled to the rigid arm 981 or brake disc 960 or may be entirely separable therefrom.

Braking mechanism D Type depicts a clamp 987 that adjustably engages with the brake disc 960 via a control wire 989. By pulling on the control wire 989, the clamp 987 closes tightly against an upper and lower surface of the brake disc 960, restricting the ability of the disc 960 to rotate with respect to the clamp 987. Alternatively, the clamp 987 may be biased in a closed position, such that pulling on the control wire 989 causes the clamp 987 to open. Either or both of the brake disc 960 and the clamp 987 may include an uneven surface and/or a high friction surface to enhance the ability of the clamp 987 to grip the disc 960. The clamp 987 may further be actuated using hydraulic or pneumatic pressure.

The braking mechanisms disclosed herein are exemplary embodiments, and one skilled in the art will appreciate the various configurations of braking structures that may be used to arrest rotational movement of the solar concentrator 900. For example, the locking mechanism may incorporate clamps, brakes, magnets, pins, hydraulics, or any other suitable mechanism for restricting movement. The brake disc 960 may be any suitable shape, size, and material, and may include any number or configuration of locking points that interface with the locking mechanism such as holes, notches, ridges, and so on. There may also be one or more braking mechanisms to restrict movement and/or rotation of the solar concentrator 900, or a component thereof, in any direction.

In another embodiment of the invention, solar concentrator 900 includes a balloon-shaped reflector having at least two separable portions. The balloon reflector may have a top portion constructed of a substantially translucent or transparent material, such as clear plastic. The bottom portion may include a reflective layer made up any suitable material such as those discussed with regard to other reflector embodiments throughout this disclosure. One example of a balloon reflector that is capable of being adapted for use in the current invention is disclosed in U.S. Patent Publication No. 2010/0108057, filed Aug. 26, 2009, and entitled “Inflatable Solar Concentrator Balloon Method and Apparatus,” the entirety of which is hereby incorporated by reference. The portions of the balloon reflector may be disposed around the crossbar 912, such that reflective portion of the balloon directs solar energy at a target placed at the center of the crossbar 912. This embodiment of the concentrator 900 may further include adjustable outer panels 906 attached to the balloon reflector or other suitable portion of the concentrator 900. The outer panels 906 may be fixed in various positions to direct solar energy toward or away from the focal point of the balloon reflector.

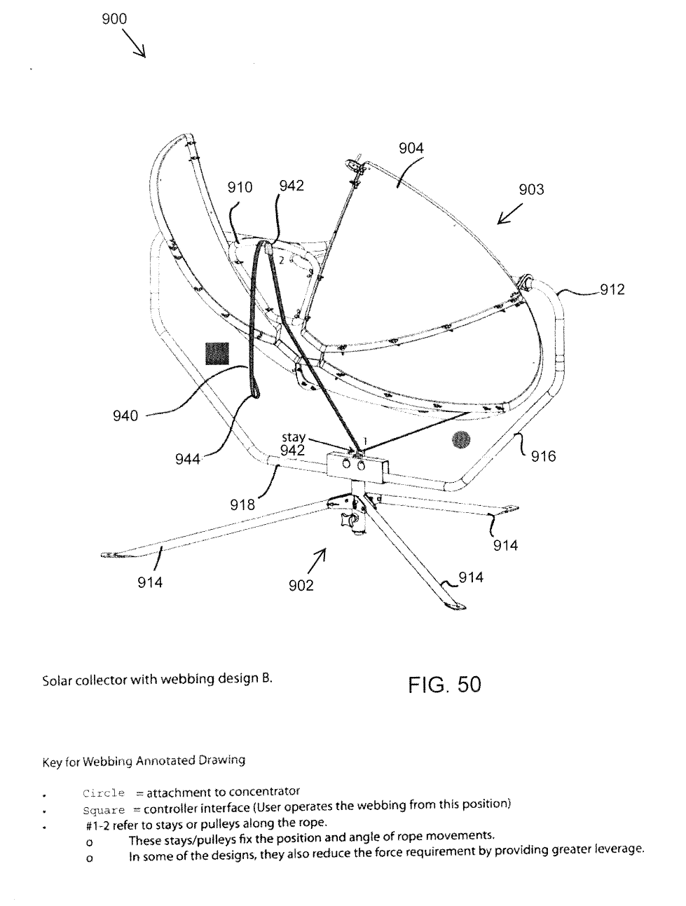

FIG. 50 illustrates one embodiment of a rigging system for adjusting the angular position of the reflective dish 903. The rigging system includes a control line 940 and one or more guides 942. When an operator pulls downward on the control portion 944 of the control line 940, the far end of the reflective dish 903 is pulled toward the operator, and the entire reflective dish 903 is effectively tilted away from the operator along the longitudinal axis of the crossbar 912.

The control line 940 may be any type of flexible cord, rope, cable, wire, webbing, string, chain, or strap, and may be constructed of cotton, nylon, polyester, or any other material of sufficient strength and smoothness to glide freely through the guides 942 without snagging or breaking. In some embodiments, the ends of the control line 940 are joined to form a continuous loop. The guides 942 fix the position and angle of the control line 940, and may be any type of suitable guide, including brackets, hooks, saddles, loops, clips, buckles, pins, and wheels, or any combination thereof. Pulleys may be used as guides to reduce the force required to adjust the reflective dish 903.

In some embodiments, the control line 940 may be automatically or manually adjusted through the use of a tracking system (not shown). An exemplary manual tracking system may include a timer to keep maintain the current time and date, and an output indicator to inform an operator how to adjust the control line 940 to direct the concentrator 900 toward the current position of the sun. An exemplary tracking system incorporating automatic functionality may include a time as described above, a motor or other suitable mechanical means to adjust the position of the control line 940, and a controller to direct the motor to move the control line 940 based on the timer, such that the concentrator 900 tracks the position of the sun in the sky. The tracking system may be powered by the concentrator 900 (i.e., solar-powered), or it may be powered by battery, hand-crank, or suitable means of power supply.

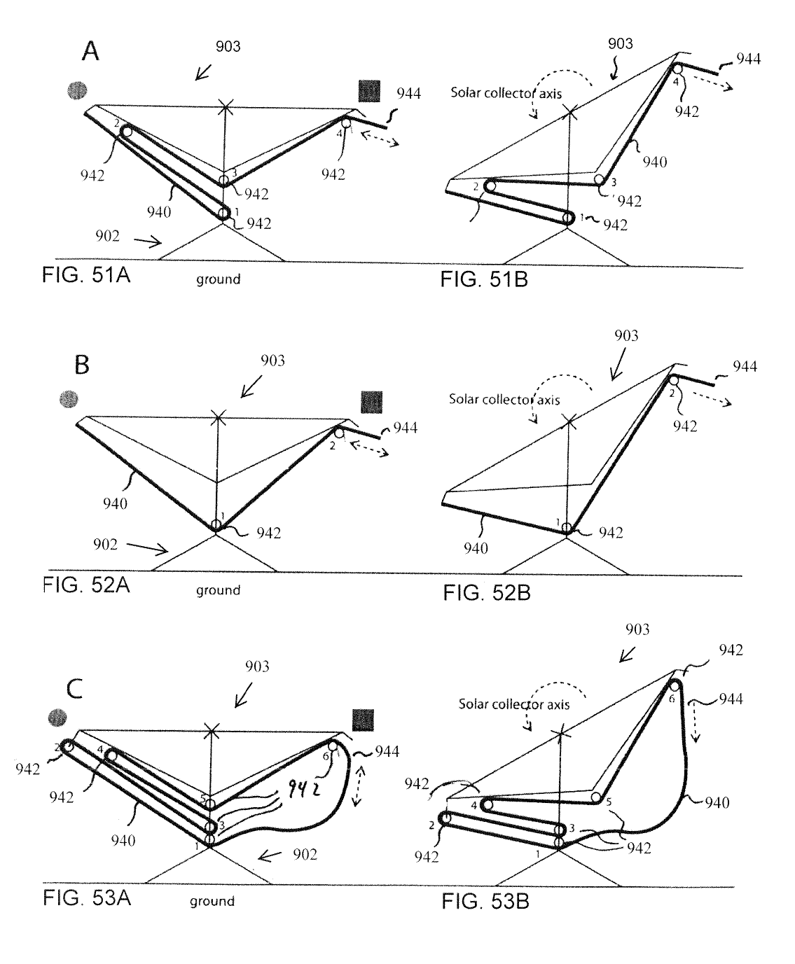

FIGS. 51a through 54b portray various embodiments of the rigging system. FIG. 51a illustrates a rigging design having four guides 942, with movement of the reflective dish 903 fixed in one direction. Two of the guides 942 act as pulleys to reduce the force required to adjust the reflective dish 903. Three of the guides 942 are arranged along the bottom of the reflective dish 903, with the fourth guide 942 affixed to the base 902. The end of the control line 940 opposite the control portion 944 is attached to one end of the dish 903. FIG. 51b shows the resulting tilt of the reflective dish 903 when the control portion 944 of the control line 940 is pulled as indicated.

FIG. 52a shows a simple rigging design having two guides 942, with movement of the reflective dish 903 fixed in one direction. This rigging design may not reduce the force required for adjustment of the reflector dish 903. One of the guides 942 is arranged along the bottom of the reflective dish 903, with the other guide 942 affixed to the base 902. The end of the control line 940 opposite the control portion 944 is attached to one end of the dish 903. FIG. 52b shows the resulting tilt of the dish 903 when the control portion 944 of the control line 940 is pulled as indicated.

FIG. 53a illustrates a rigging design having six guides 942, with movement of the reflective dish 903 fixed in one direction. This design may provide the greatest force reduction of the exemplary rigging embodiments. The control line 940 is arranged in a continuous loop, resulting in a more secure rigging system. Four of the guides 942 are arranged along the bottom of the reflective dish 903, with the two other guides 942 affixed to the base 902. FIG. 53b shows the resulting tilt of the reflective dish 903 when the control portion 944 of the control line 940 is pulled as indicated.

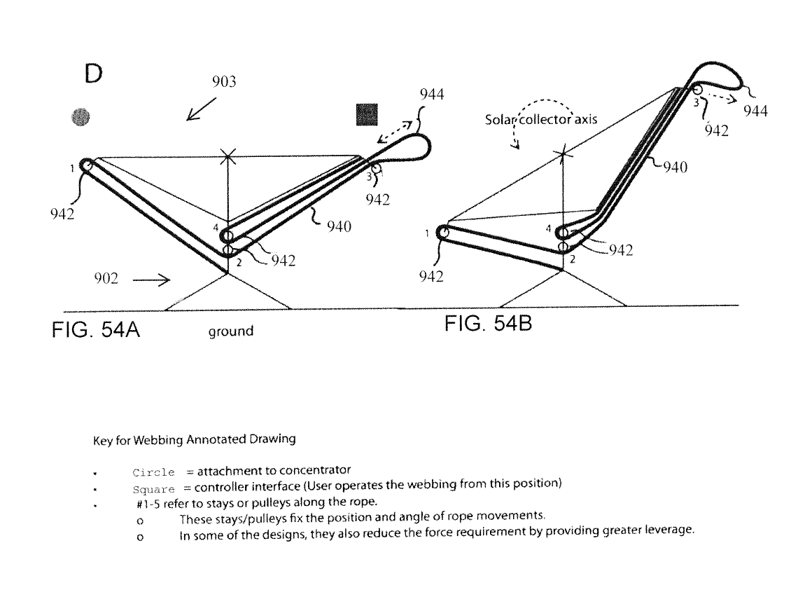

FIG. 54a illustrates a rigging design having four guides 942, with movement of the reflective dish 903 fixed in both directions. This embodiment of the rigging design may provide force reduction comparable with the design shown in FIGS. 51a and 51b. Two of the guides 942 are arranged along the bottom of the reflective dish 903, with the remainder of the guides 942 affixed to the base 902. FIG. 54b shows the resulting tilt of the reflective dish 903 when the control portion 944 of the control line 940 is pulled as indicated.

Having described certain embodiments of the invention, it will be apparent to those of ordinary skill in the art that other embodiments incorporating the concepts disclosed herein may be used without departing from the spirit and scope of the invention. The described embodiments are to be considered in all respects as only illustrative and not restrictive.

What is claimed is:

1. A portable solar concentrator comprising:
a stand;
a plurality of inner panels supported by the stand, each inner panel having at least one reflective surface, wherein the plurality of inner panels is configured to direct solar energy at a target; and
a plurality of outer panels attached to the inner panels, each outer panel having at least one reflective surface, wherein each outer panel can be configured in an active position to direct solar energy at the target and can be configured in an inactive position to direct solar energy away from the target.

2. The portable solar concentrator of claim 1, further comprising a handle disposed in an opening defined by two of the inner panels.

3. The portable solar concentrator of claim 1, wherein each outer panel is adjustably attached to an inner panel.

4. The portable solar concentrator of claim 1, wherein each outer panel is fixable in one or more positions between the active position and the inactive position.

5. The portable solar concentrator of claim 1, further comprising a crossbar supported by the stand, wherein the plurality of inner panels is suspended from the crossbar.

6. The portable solar concentrator of claim 1, wherein the inner panels are arranged to form a parabolic dish.

7. The portable solar concentrator of claim 1, wherein the outer panels are removable.

8. The portable solar concentrator of claim 1, wherein the target is disposed on the crossbar.

9. The portable solar concentrator of claim 8, further comprising a modular stand for supporting the target.

10. The portable solar concentrator of claim 1, further comprising:
at least one guide attached to the stand; and
a control line attached to at least one of the inner panels and threaded through the at least one guide, wherein an angular position of the inner panels is defined by a position of the control line with respect to the at least one guide.

11. The portable solar concentrator of claim 10, further comprising a tracking system for at least one of manually and automatically adjusting the position of the control line with respect to the at least one guide.

12. The portable solar concentrator of claim 1, wherein the portable solar concentrator comprises at least five inner panels and at least five outer panels.

13. The portable solar concentrator of claim 1, further comprising a shadow-based focusing mechanism.

14. The portable solar concentrator of claim 1, further comprising a braking mechanism for fixing a position of the portable solar concentrator.

15. The portable solar concentrator of claim 14, wherein the braking mechanism comprises a brake disc for restricting rotational movement of the portable solar concentrator.

16. The portable solar concentrator of claim 1, wherein at least one of the inner panels and the outer panels comprises a rigid frame and a reflective panel removable from the frame.

17. A method of varying a concentration of solar energy on a target, the method comprising the steps of:
placing the target in a focal area of a reflective dish;
orienting the reflective dish substantially toward a source of solar energy; and
adjusting a position of one or more outer panels attached to a perimeter of the reflective dish, such that the one or more outer panels direct solar energy at the target when in an active position and direct solar energy away from the target when in an inactive position.

18. The method of claim 17, wherein orienting the reflective dish comprises using a rigging system to adjust a position of a control line coupled to the reflective dish.
